(19) United States
(12) Patent Application Publication
(10) Pub. No.: US 2007/0088849 A1
(43) Pub. Date: Apr. 19, 2007

(54) Structured document, terminal apparatus, and apparatus for generating structured document

(76) Inventors: Akira Suzuki, Kanagawa (JP); Masami Mori, Tokyo (JP); Takefumi Hasegawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/580,128

(22) Filed: Oct. 13, 2006

(30) Foreign Application Priority Data
Oct. 18, 2005 (JP) 2005-303374

(51) Int. Cl. G06F 15/173; G06F 17/00

(52) U.S. Cl. 709/238; 715/516

(57) ABSTRACT

A structured document used in a terminal apparatus is disclosed. The terminal apparatus includes a network function including a socket waiting unit for waiting for socket connection at a predetermined port number and a socket connecting unit for connecting to a socket at the predetermined port number. The structured document includes a program part and a contents part, and the program part includes: program code for causing the terminal apparatus to function as an information distribution unit having a transfer unit for sending information received from a connected socket to another connected socket; and program code for causing the terminal apparatus to function as an information send and receive unit for connecting to the socket waiting unit for the information distribution unit so as to send and receive information.

### BACKGROUND OF THE INVENTION

1. Field of the Invention

The present invention relates to techniques on a structured document that can be used for performing communications between documents over a computer network. More particularly, the present invention relates to techniques for performing communications between documents in which displaying, editing and the like are performed in both sides of the documents without using a server-client scheme.

2. Description of the Related Art

In the past, the server-client scheme is generally used for performing communications on a computer network (refer to Japanese Laid-Open Patent Applications No. 2004-252877 (patent document 1) and 2004-235696 (patent document 2), for example). In addition, Japanese Laid-Open Patent Application No. 2003-15941 (patent document 3) that was filed by the applicant discloses a structured document (encapsulated document) to which a program is added.

Currently, communication techniques between computers such as the Internet are developed so that various information are transmitted as digital information to be used. In the techniques, IP (Internet Protocol) and TCP (Transmission Control Protocol) are particularly advanced so that communications between computers are generally performed by TCP/IP. In the TCP/IP, a communication partner on the computer network is specified by an IP address and a port number so that a communication route is virtually determined so as to perform communications.

Generally, when communications are performed between computers, there are a server that waits for a connection and a client that connects to the server. The WWW (World Wide Web) server on the Internet monitors a port 80 to wait for a connection. On the other hand, a general personal computer that is a client connects to a destination server by the port 80 with an application program called Web browser so as to obtain and display a Web page. Such scheme is called the server-client scheme.

Other than the server-client scheme, a P2P scheme is used in which personal computers are connected with each other in a peer-to-peer fashion. However, since a connection is established based on a combination of the IP address and the port number in these schemes and the connection is established based on a particular port, there is a fear that an illegal access may occur when the port number is known by a third party. In view of this technical background, the patent document 1 discloses a technique to prevent illegal access by changing the port number periodically.

In addition, the patent document 2 discloses a file transfer communication service for specifying a same port number in both ends of communication terminals so as to perform priority control and bandwidth assurance for communications using the port number.

By the way, an application of the present invention is network communications using documents. Generally, the document dealt with by a computer is a digital information file complying with a standard file format. As shown in FIG. 1 for example, a computer reads a document file 1 using an application program 2 for displaying, generating, editing and the like so that the file is treated as a document.

That is, generally, the document file can be used by using such application program, and the document file itself is merely digital data including contents of a document. The document file can be displayed, generated, and edited only by using such application program.

As disclosed in the patent document 3, the applicant has proposed an encapsulated document in which a program for displaying and operating the document is added to the document file. In general, the document file has a structure shown in FIG. 2.

By the way, conventionally, communications on the network are performed using particular network communication application programs 3 and 4 as shown in FIG. 3.

### SUMMARY OF THE INVENTION

In view of the conventional communication techniques and the above-mentioned conventional encapsulated document technique, it is useful if communications can be performed between documents over a network by adding network communication functions to the encapsulated documents. An object of present invention is to realize enhanced document communications by providing an optimal method for realizing network communication functions of encapsulated documents (structured documents).

The object is achieved by a structured document used in a terminal apparatus including a network function including a socket waiting unit for waiting for socket connection at a predetermined port number and a socket connecting unit for connecting to a socket at the predetermined port number, the structured document including a program part and a contents part, the program part including:

program code for causing the terminal apparatus to function as an information distribution unit having a transfer unit for sending information received from a connected socket to another connected socket; and

program code for causing the terminal apparatus to function as an information send and receive unit for connecting to the socket waiting unit for the information distribution unit so as to send and receive information.

The object is also achieved by a terminal apparatus including a network function including a socket waiting unit for waiting socket connection at a predetermined port number and a socket connecting unit for connecting to a socket at the predetermined port number, and further including a structured document and a launching program, the structured document including:

program code for causing the terminal apparatus to function as an information distribution unit having a transfer unit for sending information received from a connected socket to another connected socket; and

program code for causing the terminal apparatus to function as an information send and receive unit for connecting to the socket waiting unit for the information distribution unit so as to send and receive information, and

the launching program including a unit for causing the terminal apparatus to execute program code in the structured document.

According to the present invention, enhanced document communications can be realized by providing an optimal method for realizing network communication functions of encapsulated documents (structured documents).

### BRIEF DESCRIPTION OF THE DRAWINGS

Other objects, features and advantages of the present invention will become more apparent from the following detailed description when read in conjunction with the accompanying drawings, in which:

FIG. 1 is a figure for explaining a conventional document file;

FIG. 2 is a figure showing an encapsulated document;

FIG. 3 is a figure for explaining conventional network communications;

FIG. 4 is a figure showing network communications among documents;

FIG. 5 is a figure for explaining general operation of the encapsulated document;

FIG. 6 shows network communications between a transfer process and send/receive processes;

FIG. 7 shows processes and operation in documents A and B;

FIG. 8 shows an example of communications among PCs;

FIG. 9 shows another example of communications among PCs;

FIG. 10 shows a configuration of a transfer process;

FIG. 11 shows a configuration of a send/receive process;

FIG. 12 show operation of a document that is launched;

FIG. 13 is a flowchart showing operation of the transfer process;

FIG. 14 is a figure for explaining process and thread;

FIG. 15 is a flowchart showing operation of the send/receive process;

FIGS. 16A-16C show operation of a socket waiting thread, a receive thread and a send thread respectively;

FIG. 17 is a flowchart showing operation of an information distribution thread;

FIG. 18 is a figure for explaining information distribution;

FIG. 19 is a flowchart showing operation of a receive thread of the send/receive process;

FIG. 20 is a flowchart showing operation of a send thread of the send/receive process;

FIG. 21 shows an example of a send/receive process of a document;

FIG. 22 is a flowchart showing operation of the send/receive process;

FIG. 23 shows operation of the send/receive process and the transfer process in the example;

FIG. 24 shows transfer of writing information;

FIG. 25 shows an example of connections among the send/receive process and the transfer processes;

FIGS. 26A-26C show operation of the socket connecting unit, the receive thread and the send thread respectively;

FIG. 27 shows a format of a message;

FIG. 28 is a figure for explaining message numbers;

FIG. 29 shows operation including message transmission shown in FIG. 28;

FIG. 30 shows a message format of message number 2;

FIG. 31 is a flowchart showing operation of an information distribution thread;

FIG. 32 is a flowchart showing operation in step 66;

FIG. 33 shows another configuration of a transfer process;

FIG. 34 is a flowchart showing operation of a receive program locate unit;

FIG. 35 is a flowchart showing operation of the information distribution thread;

FIG. 36 is a flowchart showing operation of the send/receive process;

FIG. 37 shows an example of operation of the send/receive process for sending program code;

FIG. 38 shows another configuration of an encapsulated document;

FIG. 39 shows a launching program;

FIG. 40 shows operation of the launching program;

FIG. 41 is a flowchart showing operation of a start program;

FIG. 42 shows operation of an encapsulated document process;

FIG. 43 is a flowchart for explaining operation of documents A and B;

FIG. 44 shows processes operating in computers in document A side and document B side;

FIG. 45 is a figure for explaining connections among documents;

FIG. 46 is an example of a screen displayed when a document is launched;

FIG. 47 shows an example of an input frame;

FIG. 48 shows an example of a frame for entering connection permission;

FIG. 49 shows communications between two computers;

FIG. 50 is a sequence chart showing message transmission; and

FIG. 51 shows an example of a document generation edit program.

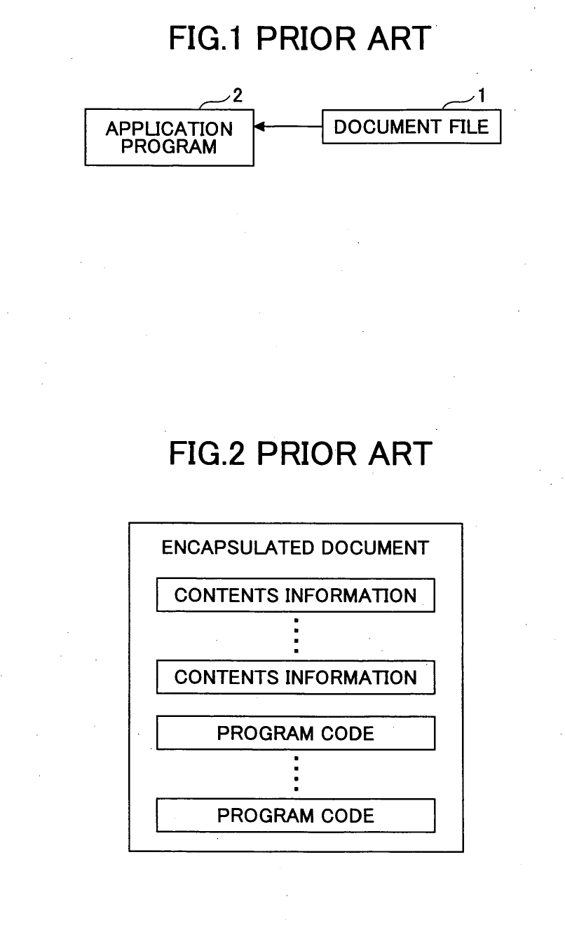

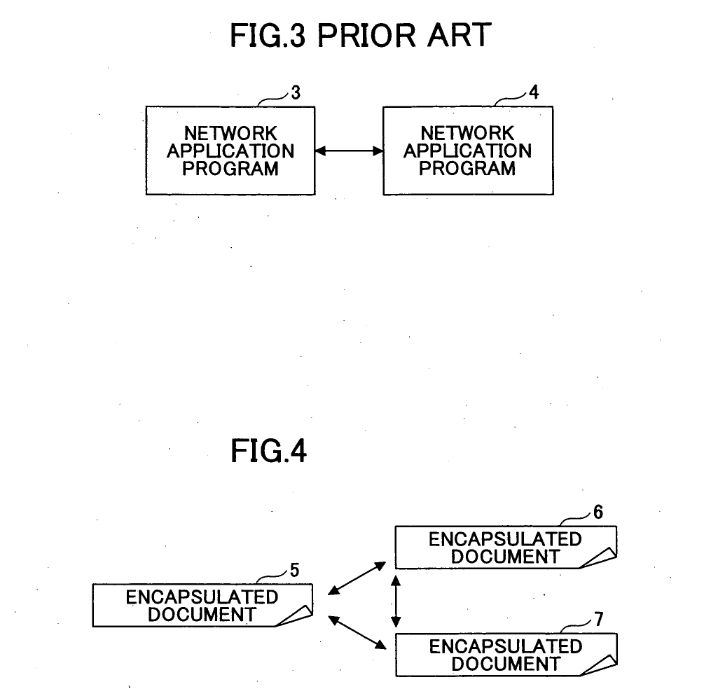

### DETAILED DESCRIPTION OF THE PREFERRED EMBODIMENTS

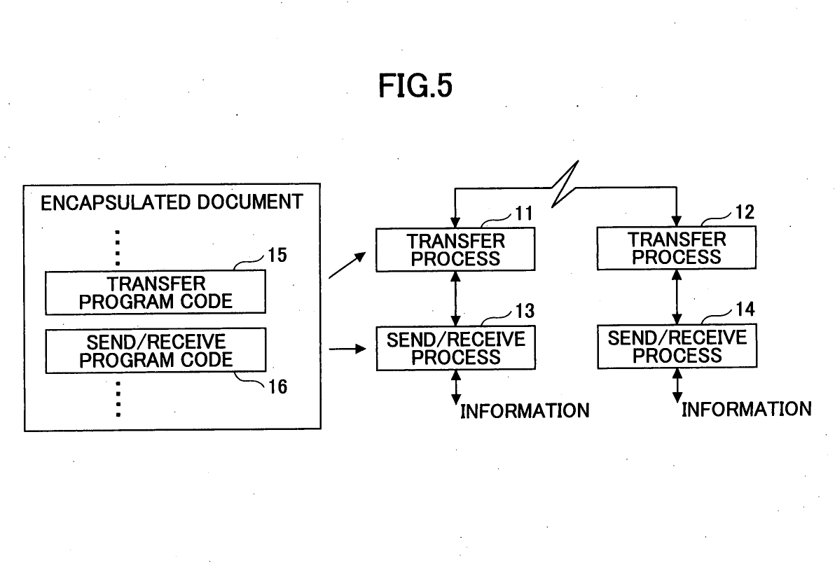

In embodiments of the present invention, by adding network communication functions to the encapsulated document, network communications can be performed among documents 5, 6 and 7 as shown in FIG. 4.

In a file structure of the encapsulated document including contents of a document and program code, there are transfer program code 15 and send/receive program code 16 as program codes as shown in FIG. 5. The transfer program code 15 is interpreted and executed by the computer and operates as a transfer process. The send/receive program code 16 is interpreted and executed by the computer and operates as a send/receive process.

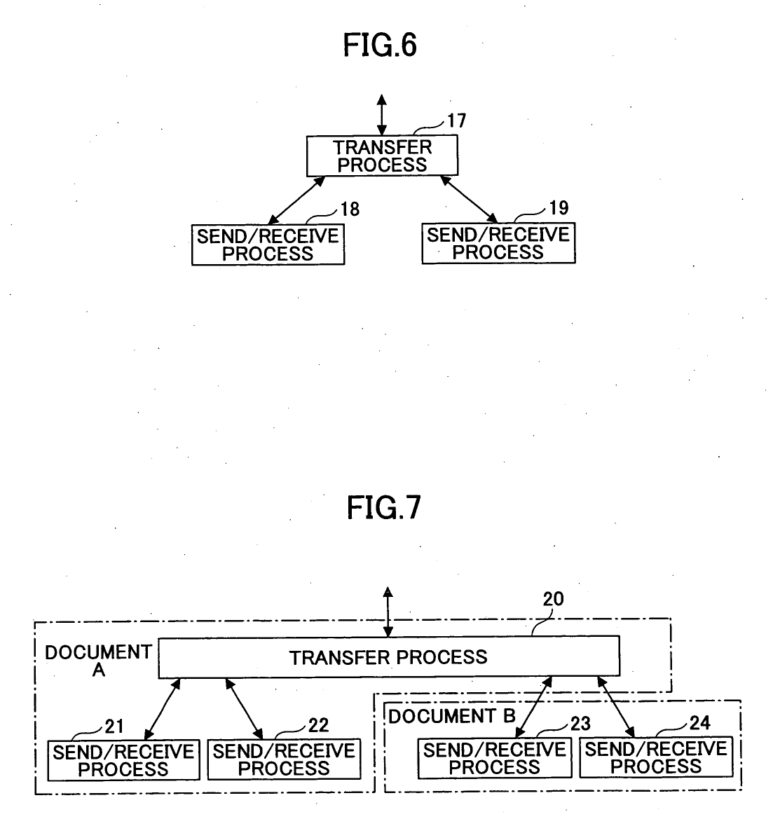

That is, as shown in FIG. 5, a transfer process 11 sends information received from a send/receive process 13 to another transfer process 12, receives information sent from the transfer process 12 and sends the information to the send/receive process 13. The send/receive process (13, 14) sends obtained information to the transfer process (11, 12), and receives information from the transfer process (11, 12). In addition, as shown in FIG. 6, a transfer process 17 receives information from plural send/receive processes 18 and 19, and transfers the information, and distributes information from another transfer process to plural send/receive processes 18 and 19.

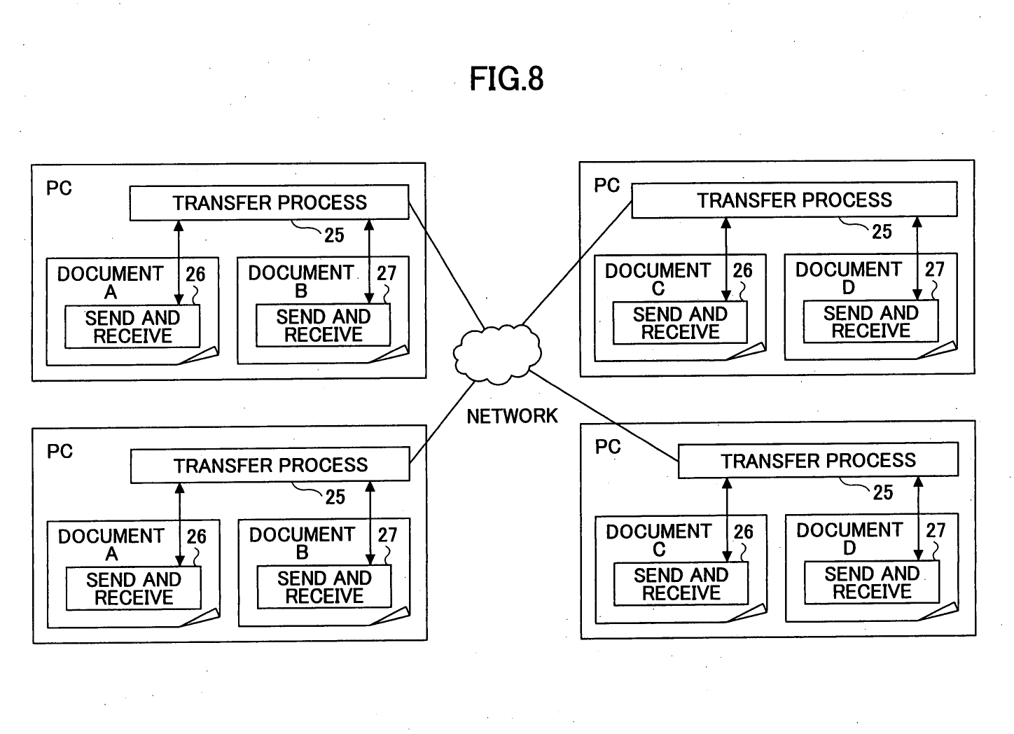

In addition, as shown in FIG. 7, when there are a transfer process 20 and send/receive processes 21 and 22 in a document A, the transfer process 20 of the document A obtains information and distributes the information to the send/receive process 21 or 22, or to both of them, and also the transfer process 20 can obtain information from send/receive processes 23 and 24 of the document B and distribute the information. That is, as shown in FIG. 8, on each PC, a transfer process 25 operates so as to obtain information from send/receive processes 26 and 27 of plural documents A and B, and transfer the information to a transfer process of another PC. In addition, the transfer process 25 obtains information transferred from a transfer process operating on another PC and distributes the information to the send/receive processes 26 and 27 on the PC.

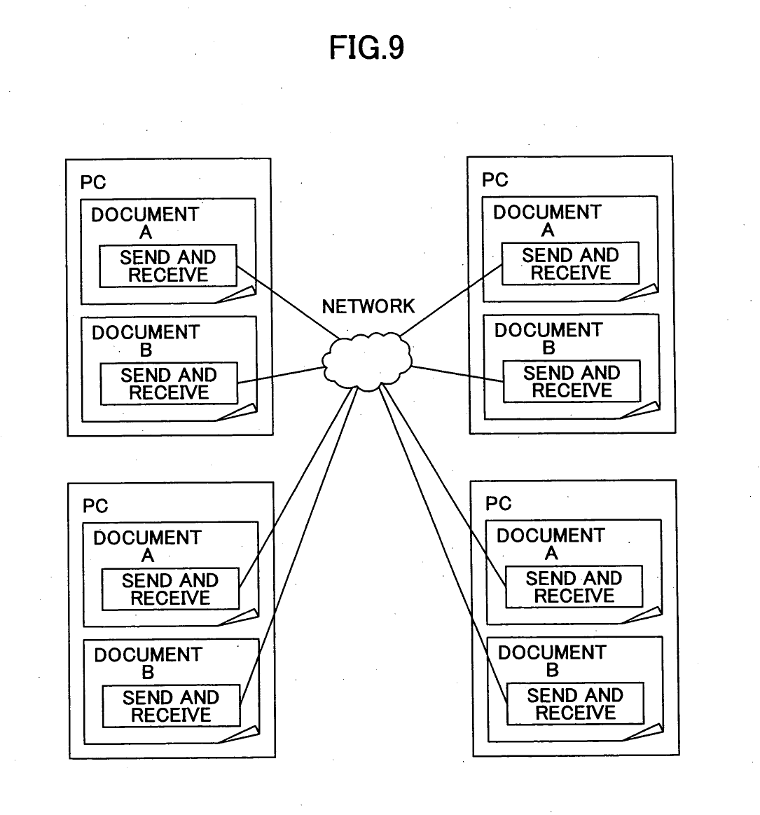

The send/receive process can also send/receive information via the network without using the transfer process. In this case, more connections become necessary as shown in FIG. 9. In addition, in this case, it becomes necessary that the documents A and B wait for connections using different ports with each other.

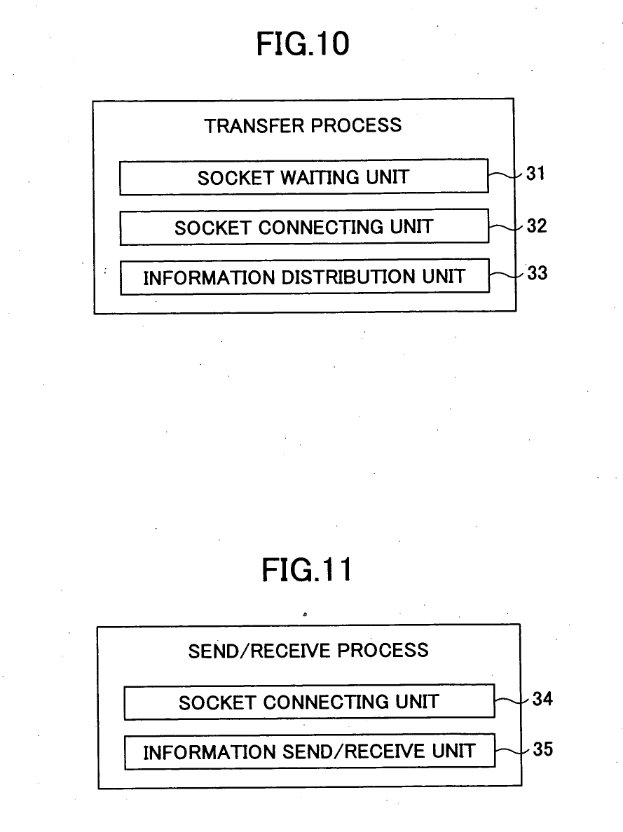

Next, configuration and operation of the transfer process and the send/receive process are described. As shown in FIG. 10, the transfer process includes a socket waiting unit 31 for waiting for socket connection, a socket connecting unit 32 for connecting to a socket waiting unit of another transfer process in another computer, and an information distribution unit 33 for sending information that is received via a connected socket to another process via another socket. As shown in FIG. 11, the send/receive process includes a socket connecting unit 34 for connecting to a socket waiting unit 31 of the transfer process, and an information send/receive unit 35 for sending/receiving information of the connected socket.

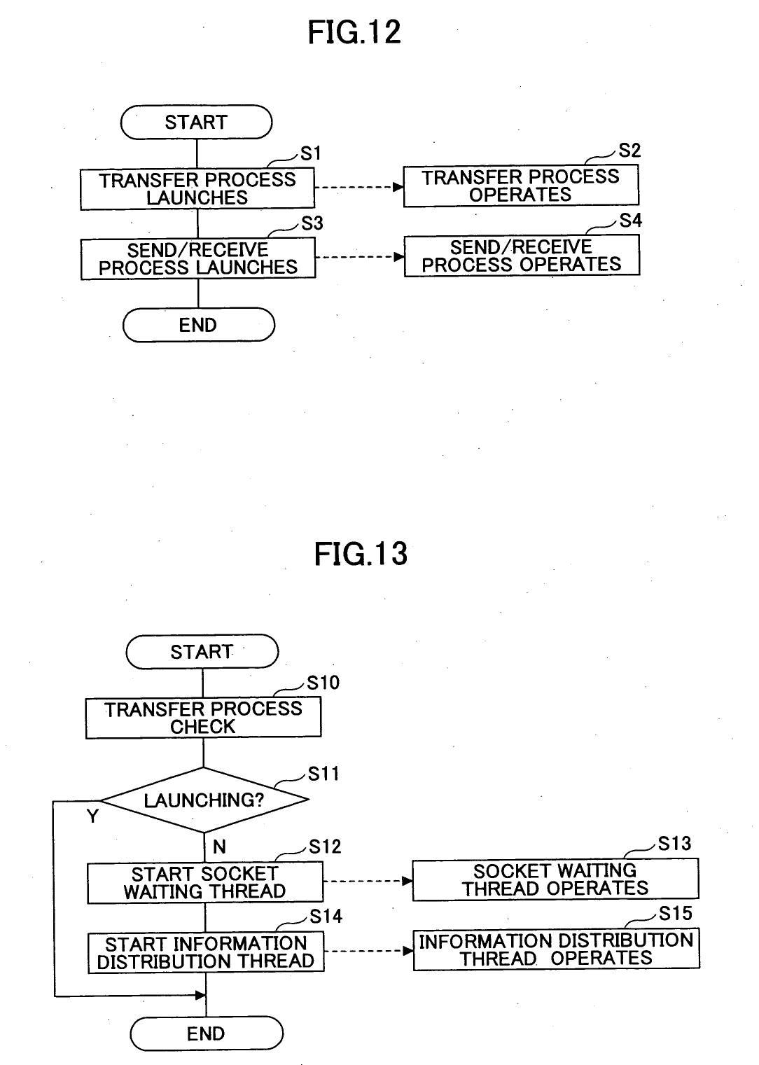

As shown in FIG. 12, when a document is launched, an after-mentioned launch program reads the transfer program code in the document so that the transfer process is launched in step 1 and the transfer process operates in step 2 in the computer. Next, the launch program launches the send/receive process so that the send/receive process operates in steps 3 and 4, and a main routine ends. Next, outline operation of the launched transfer process is described as follows. As shown in FIG. 13, the transfer process checks whether another transfer process operates in the computer in step 10.

In this checking, the transfer process may ask the operating system in the computer about operating status of processes. Since a socket waiting thread is waiting for a socket connection at a particular port when another process is operating as described later, the transfer process may detect this. Generally, a computer cannot wait for plural socket connections with a single port, because if different programs connects to the single port, information to be sent/received are mixed.

When another transfer process is operating (Y in step 11), the transfer process is ended. When another transfer process is not operating (N in step 11), a socket waiting thread for waiting for a socket connection starts in step 12 so that the socket waiting thread operates in step 13, and an information distribution thread for distributing information received by a socket starts in step 14 and the information distribution thread operates in step 15 so that the launching operation for the transfer process ends.

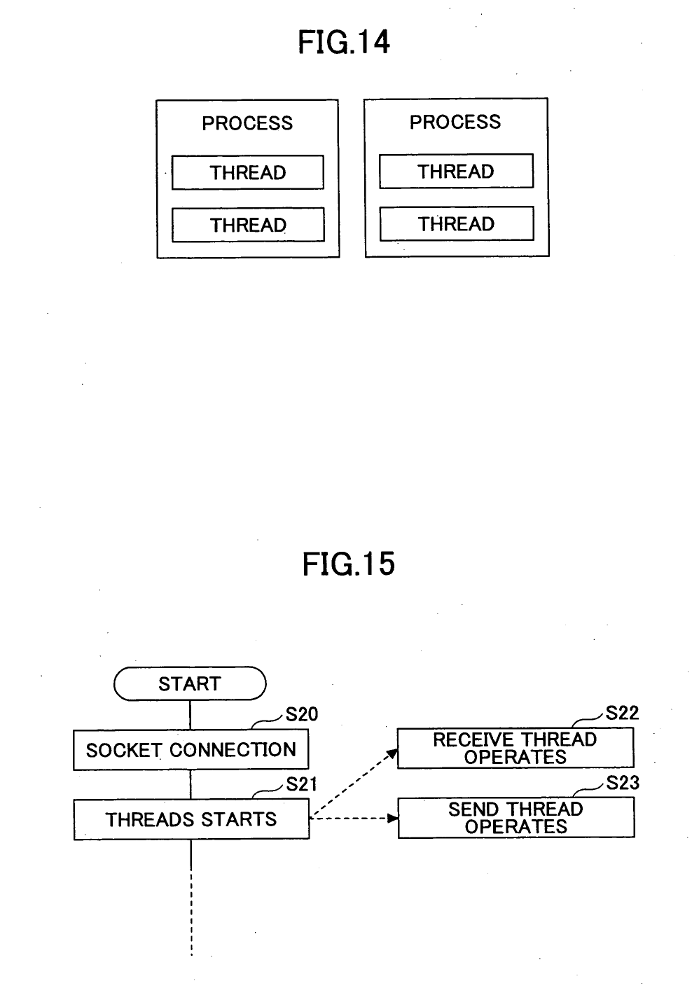

Both of the terms “process” and “thread” are terms on multitask functions on general operating systems. The “process” operates independently and does not share a memory with another process. Plural threads can operate concurrently in the process and share a memory among threads as shown in FIG. 14.

Next, the send/receive process is described. As shown in FIG. 15, when the send/receive process is started, the send/receive process connects to a port that is monitored by the socket waiting thread of the transfer process first in step 20. After the connection, the send/receive process launches a receive thread for receiving information from the connected socket and a send thread for sending information to the connected socket in step S21 so that the receive thread and the send thread operate in steps 22 and 23. Then, the send/receive process performs further processes.

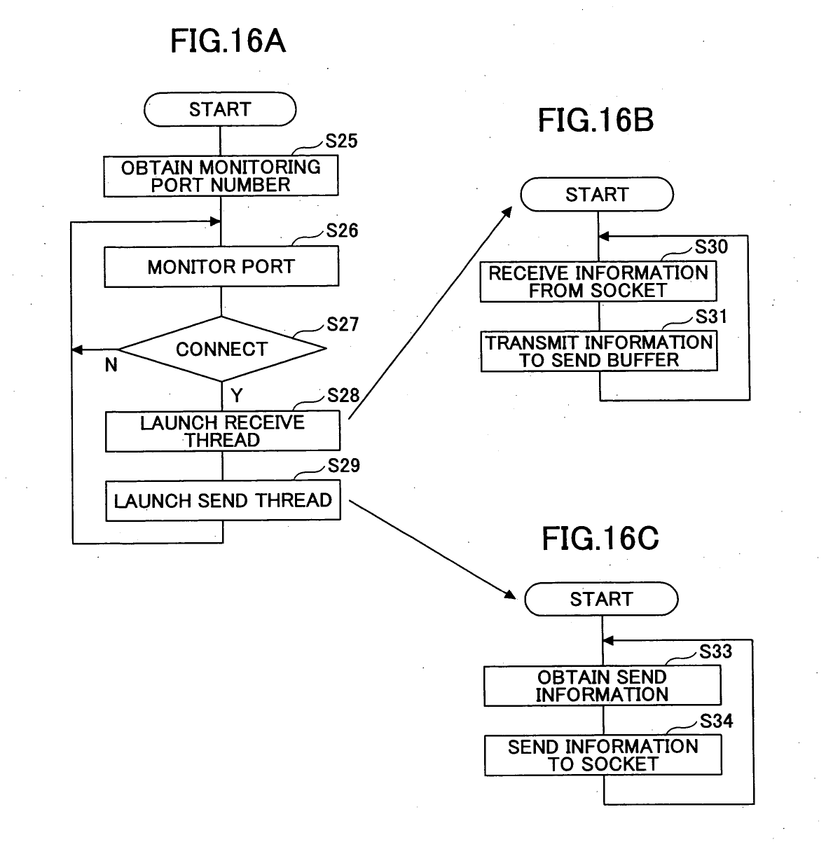

Next, the socket waiting thread, the information distribution thread, the receive thread and the send thread are described. As shown in FIG. 16A, the socket waiting thread obtains a port number by which the socket waiting thread waits for a connection first in step 25. In this operation, if the port number is a fixed number, the fixed number may be described in the program, or the number may be set in the network document. In addition, a dialog may be displayed for prompting a viewer to enter a port number when the document is launched.

Next, the socket waiting thread monitors a connection request at the obtained port number until the connection request occurs in steps 26 and 27. When the connection request occurs, the receive thread and the send thread are launched as shown in FIGS. 16B and 16C respectively in steps 28 and 29, and returns to port monitoring. The receive thread repeats a loop in which when the receive thread receives information from a connected socket in step 30, the receive thread passes the information to a send buffer in step 31. The send thread repeats a loop to obtain send information and send the obtained information to a connected socket in steps 33 and 34.

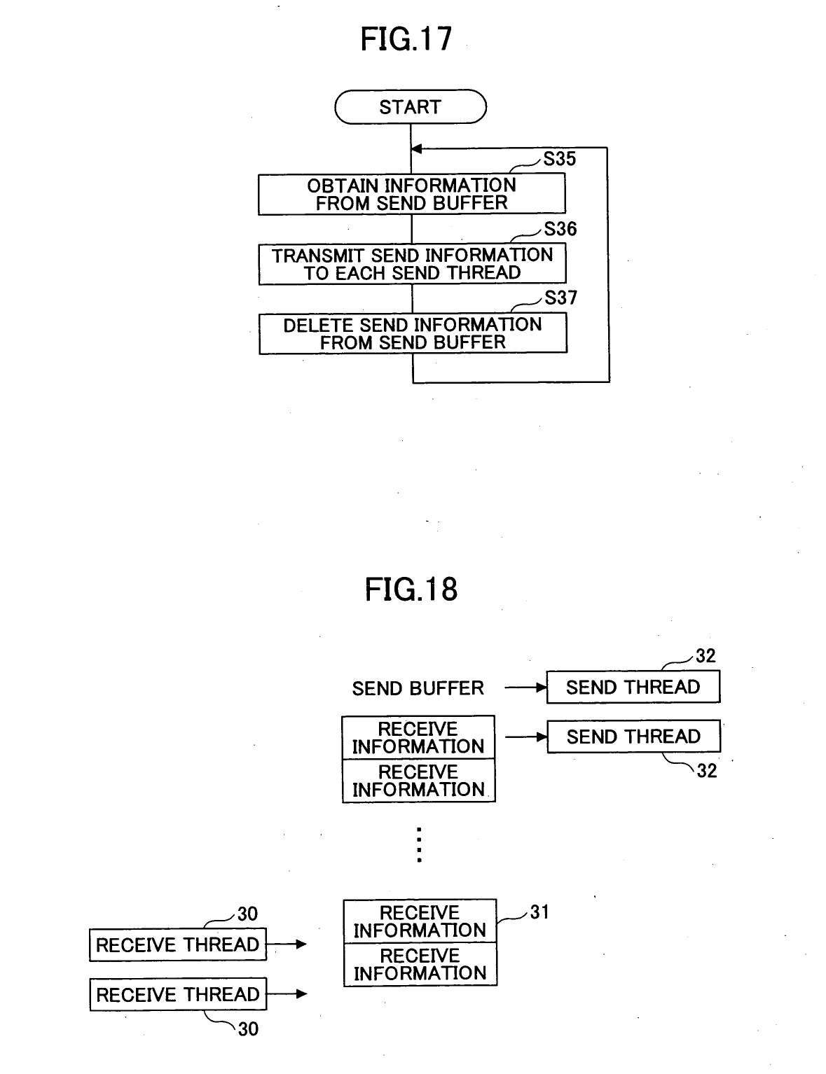

As shown in FIG. 17, the information distribution thread repeats a loop for obtaining information from the send buffer in step 35, and transmitting the information to each send thread in step 36, and deleting the information from the send buffer in step 37. That is, as shown in FIG. 18, when a socket is connected to the socket waiting thread, each receive thread 30 transmits its received receive information 31 to the send buffer and the information distribution thread obtains the received information from the send buffer to transmit the received information to the send thread 32 so that the send thread transmits the information. Accordingly, the transfer process can distribute information by sending information received from a connected socket to another connected socket.

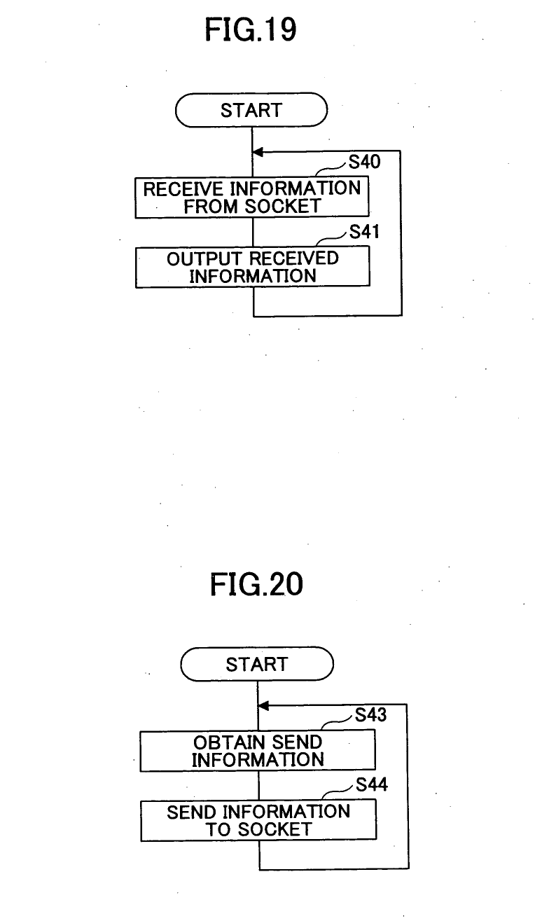

Next operation of the receive thread and the send thread of the send/receive process in FIG. 15 is described. As shown in FIG. 19, the receive thread of the send/receive process repeats operation for receiving information from a socket in step 40, and outputting the received information in a form in step 41. As shown in FIG. 20, the send thread repeats operation for obtaining send information in step 43 and sending the information to a socket in step 44.

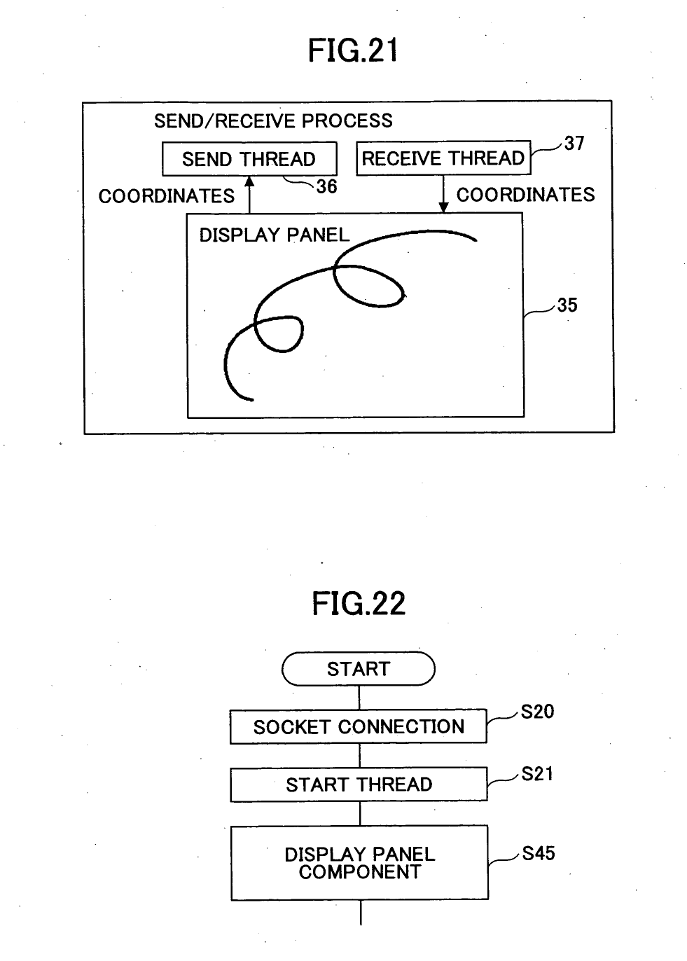

For example, in addition to the operation for socket connection and thread launching shown in FIG. 15, when the document is a panel for displaying writing information shown in FIG. 21, the send/receive process causes a display panel component to operate having functions for displaying a display panel 35 and obtaining writing coordinates in step 45 as shown in FIG. 22. That is, the display panel component detects mouse operation within a display area and sends coordinates to the send thread 36, or receives coordinates from the receive thread 37 so as to display line segments based on the coordinates so that it can display lines based on movement of the mouse.

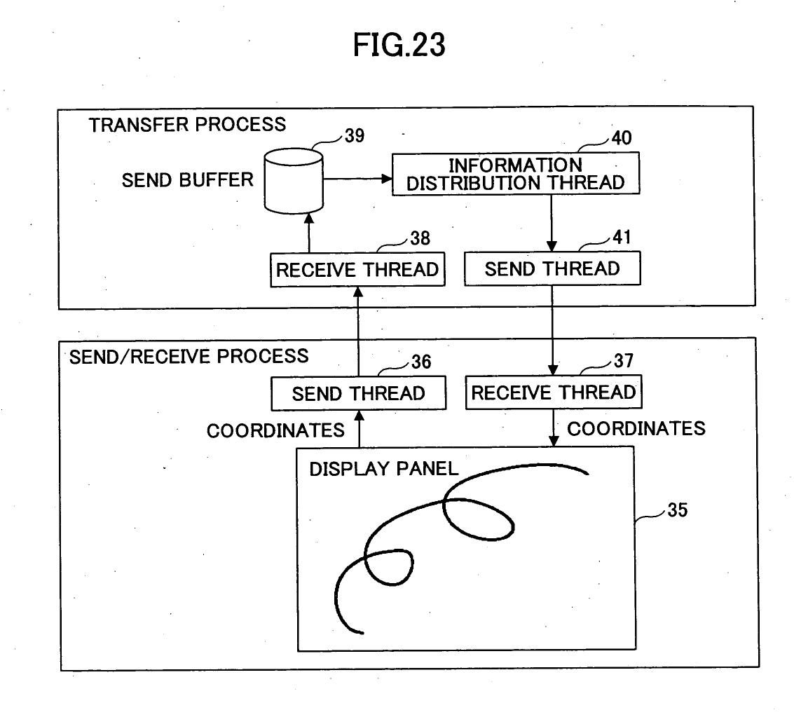

Accordingly, as shown in FIG. 23, the display panel component displaying the display panel 35 obtains the mouse coordinates, transmits the coordinates to the send thread 36 of the send/receive process, and the send thread 36 sends the transmitted information to the transfer process via sockets. Then, the receive thread 38 in the transfer process receives the information via a socket of the transfer process and sends the information to the send buffer 39. In addition, the information distribution thread 40 obtains the received information from the send buffer 39, and sends the information to the send thread 41, so that the send thread 41 sends the information to the receive thread 37 of the send/receive process via sockets.

In addition, the receive thread 37of the send/receive process sends the received information to the display panel 35, so that the display panel 35 displays the received coordinate information as a line segment. Then, the socket waiting unit of the transfer process establishes connections for connection requests from plural send/receive processes. In this example, since processes are connected as shown in FIG. 7, information of the document A is distributed to the document B at the same time.

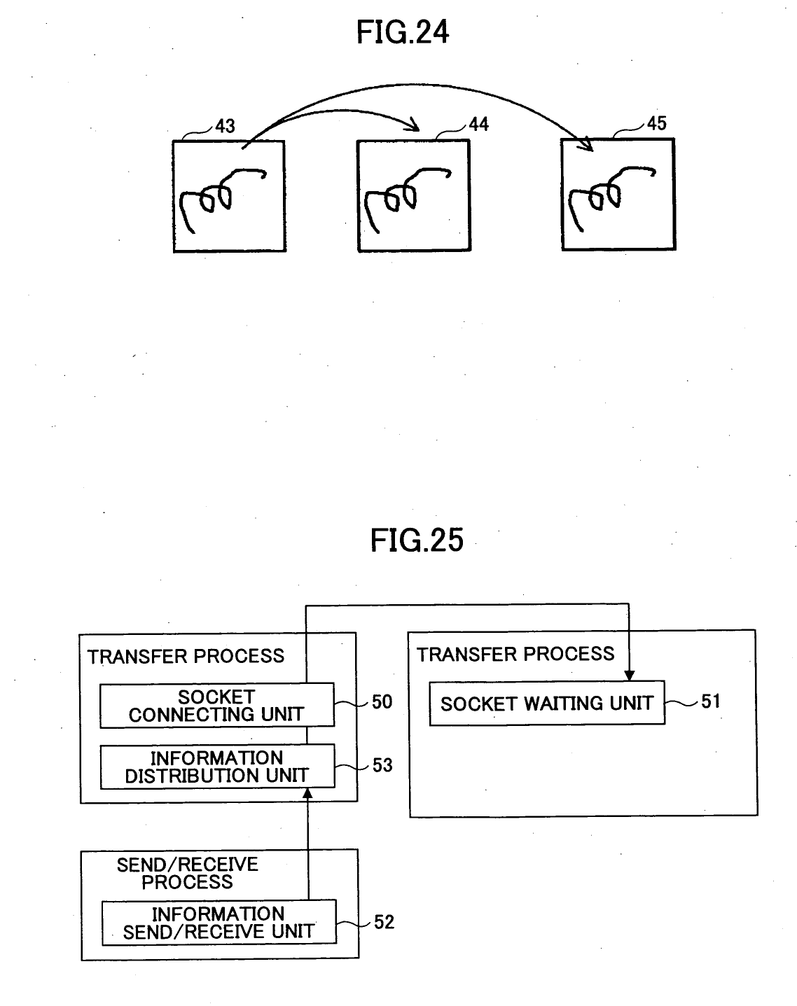

Accordingly, when a mouse is moved for writing on a display component, a line segment is displayed on plural components at the same time. That is, as shown in FIG. 24, writing operation on a display component 43 is transmitted to other display components 44 and 45 via the transfer process.

Information transmission between the transfer process and the send/receive process is described so far. Next, communications between transfer processes are described. That is, so far, operation is described in which the transfer process is connected to the send/receive process by sockets based on a connection request by the socket connecting unit of the send/receive process, so that the send/receive process sends/receives information to other send/receive process via the transfer process.

On the other hand, in this case, as shown in FIG. 25, a socket connecting unit 50 of the transfer process performs socket connection to a socket waiting unit 51 of other transfer process in response to a connection request from a send/receive process. That is, as shown in FIG. 25, an information send/receive unit 52 that is already socket-connected to the transfer process sends a connection request to the information distribution unit 53 of the transfer process, so that the transfer process connects to the socket waiting unit 51 of other transfer process by sending a connection request so that socket connection between transfer processes can be established.

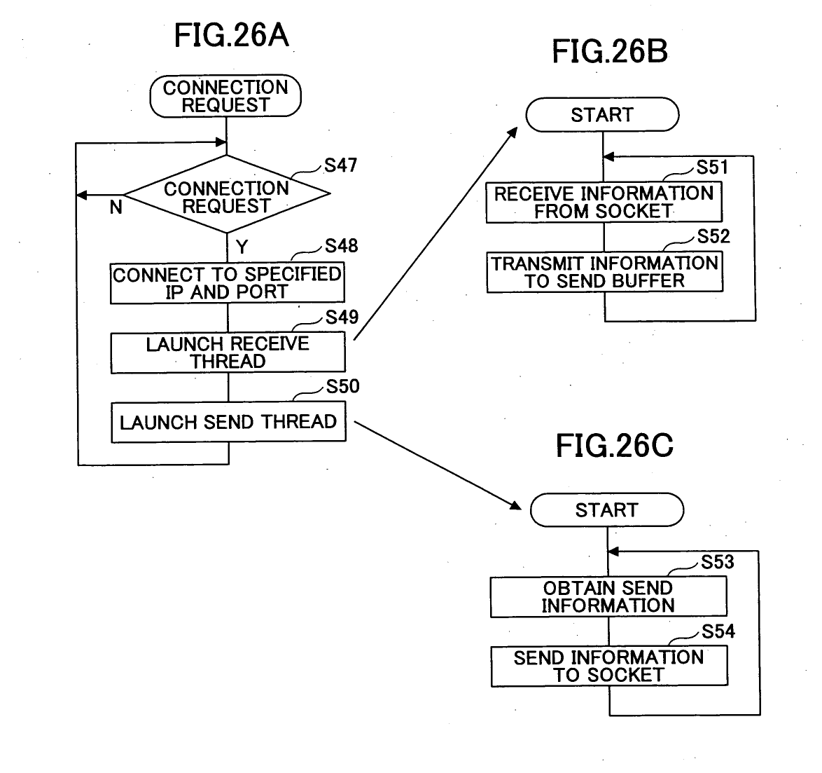

More particularly, as shown in FIG. 26A, when receiving the connection request, the socket connecting unit 50 connects to a destination transfer process with a specified IP and a specified port in steps 47 and 48. After that, the socket connecting unit 50 launches the receive thread and the send thread in steps 49 and 50 in the same way as the connection waiting thread shown in FIG. 16A. In the receive thread and the send thread as shown in FIGS. 26B and 26C, received information is transmitted to the send buffer (steps 51 and 52) and the received information is obtained through the information distribution thread so that the send thread sends information in the same way shown in FIG. 16C (steps 53 and 54).

In this case, the send thread and receive thread that perform send/receive operation using sockets connected by the socket waiting unit are not substantially different from the send thread and receive thread that perform send/receive operation using sockets connected by the socket connecting unit. They are different only in a point whether socket connection is established passively by the socket waiting unit or socket connection is established actively by the socket connecting unit.

In addition, in a transfer process, there is no difference between send/receive threads used when transfer processes connect each other and send/receive threads used when the transfer process connects to the send/receive thread. That is, each thread performs in the same way in the transfer thread.

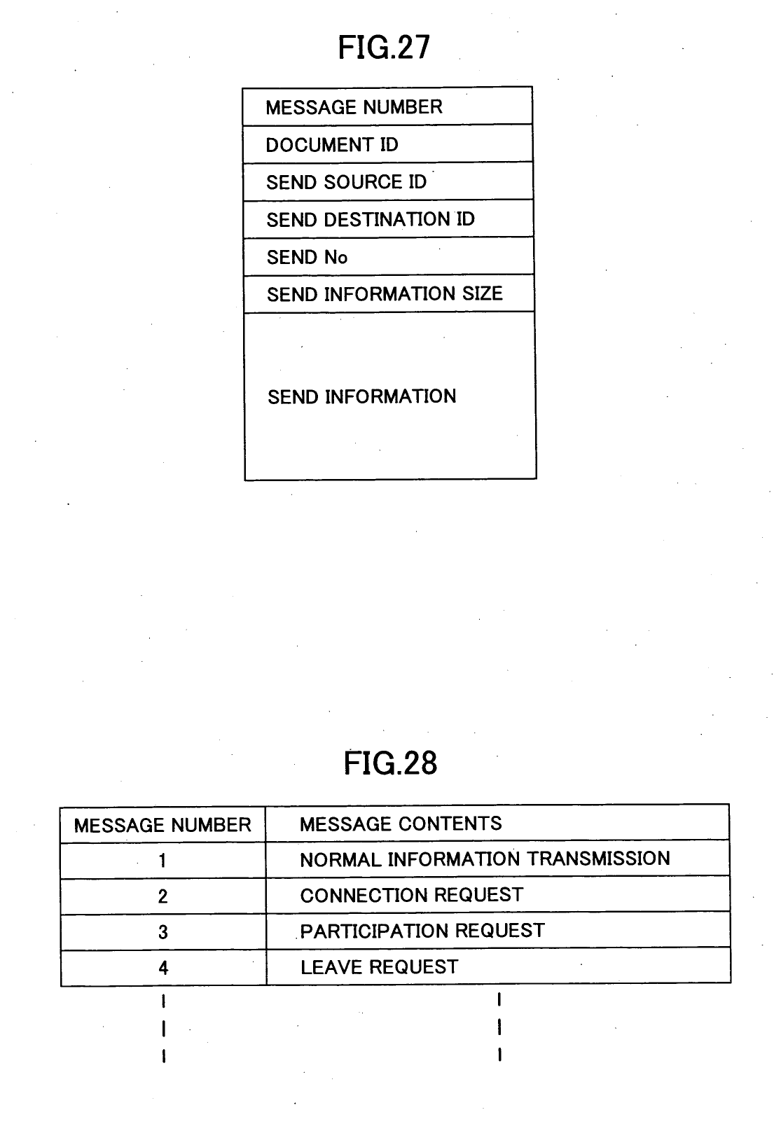

Next, an information transmission method including the before-mentioned connection request is described. Each of the transfer process and the send/receive process transmits information of a format shown in FIG. 27. The message number shown in FIG. 27 is a number for indicating a type of information that is sent/received. According to the number, a type of a received message can be identified. The document ID is an ID specific to the document. By the ID, the document can be identified. More particularly, it can be used for sending send information from different types of documents to a same type of documents.

By using the send source ID, a send source can be identified so that it can be used for discarding unnecessary information. The send destination ID can be used for sending information to a particular destination. The send No is a serial number of information to be sent. By using the send No, information that has not yet been sent can be detected. The send information size can be used for specifying a size of the send information.

By using such format of the information, a terminal which receives the information can ascertain what type of information is received by checking the items in the format even though the contents of the information are not known. This format is an example for explanation, and other formats can be used.

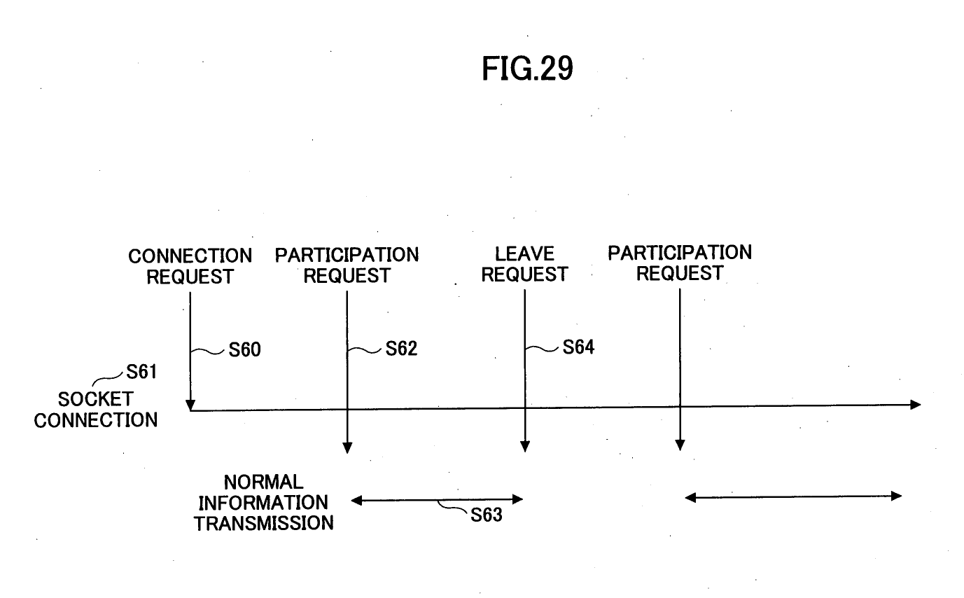

Next, the message number that indicates a type (kind) of the information is described. As shown in FIG. 28, the number “1” indicates normal information sending, the number “2” indicates a connection request for requesting a connection to another transfer process, the number “3” indicates a participation request and the number “4” indicates a leave (walkout) request. As shown in FIG. 29, in response to a connection request from a send/receive process in step 60, a transfer process establishes a socket connection in step 61. After receiving the participation request in step 62, the transfer process sends the normal information of the number “1” to the send/receive process that sent the request in step 63. After receiving a leave request in step 64, the normal information is not sent.

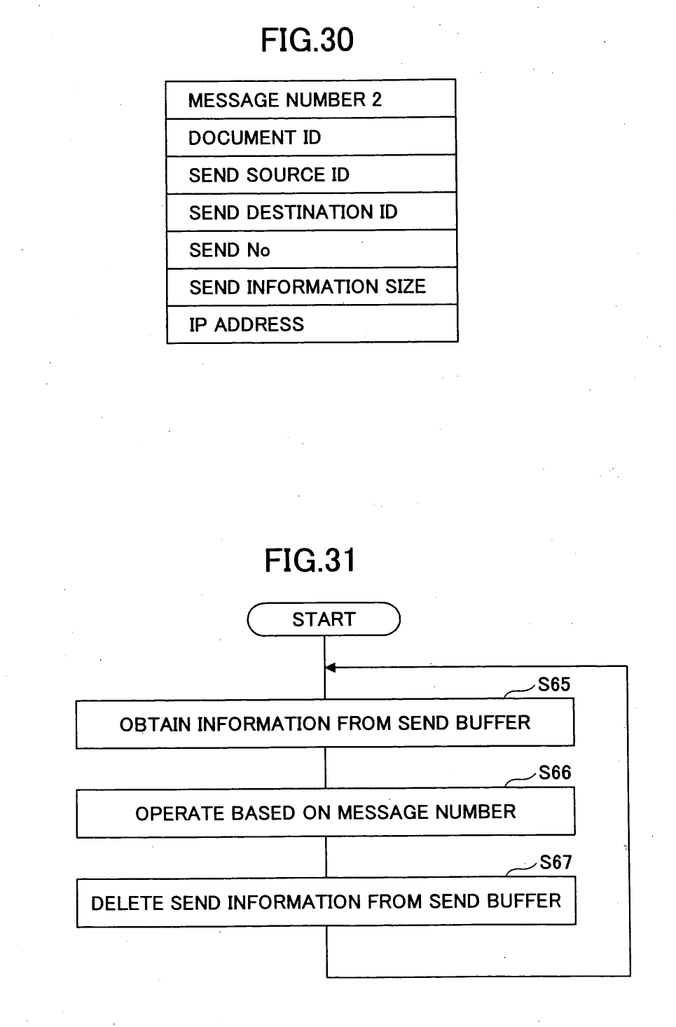

Accordingly, the send/receive unit can connect to arbitrary transfer process, and can receive or block information. That is, the send/receive process sends information having a format shown in FIG. 30 so that the send/receive process can connect to a waiting unit of a transfer process in a computer connected by the specified IP address. In addition since it is desirable to use a fixed port, it is not necessary to send a port number.

That is, the transfer process waits for a connection at a specific (predetermined) port, and uses a socket connecting unit to establish a socket connection based on the message of number “2” send from the send/receive unit, so that the transfer process can connect to arbitrary transfer process. In addition, after they are connected, information can be properly distributed according to the format of the message.

Next, portions for determining operation according to the messages are described. For this purpose, the procedure shown in FIG. 16C is changed to the procedure shown in FIG. 31. That is, the receive thread of the transfer process receives information and transmits the information to the send buffer. Then, the information distribution thread obtains the information from the send buffer in step 65. Since the obtained information complies with the format shown in FIG. 27, the information distribution thread checks the message number and operates according to the message number in step 66. After that, the send information is deleted from the send buffer in step 67.

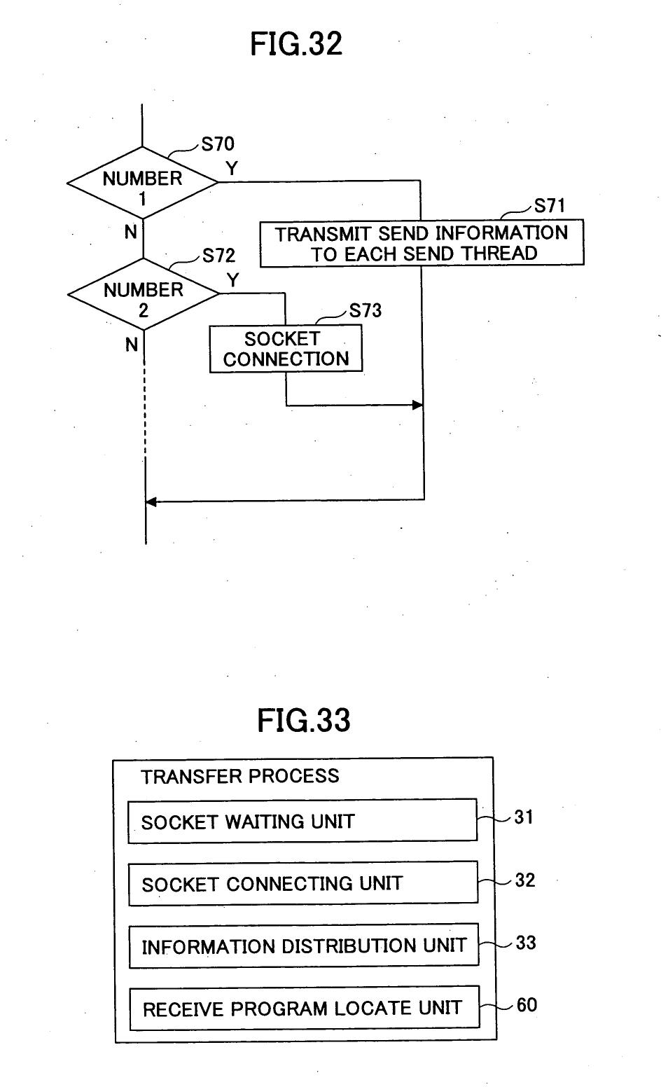

More particularly, as shown in FIG. 32, when the message number is “1” (Y in step 70), since the number “1” means the normal information transmission, the send information is transmitted to each send thread in step 71, so as to cause the send thread to send the information. When the number is “2” (Y in step 72), since it means a connection request, a socket connection is performed in step 73 in a way as shown in FIG. 26A.

Accordingly, send information is generated as a form of the message of the format shown in FIG. 27 according to the type of the information to be transmitted by the send/receive process, and the send thread of the send/receive process sends a message to a receive thread of the transfer process, and the transfer process determines operation according to the type of the received message, so that proper operation can be performed. That is, the transfer process can operate as instructed by the send/receive process by defining the message numbers indicating the types of the messages and by performing operation corresponding to the message as shown in FIG. 31.

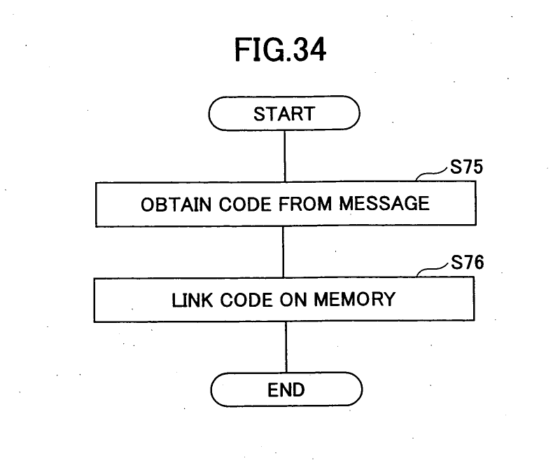

Operation corresponding to the type of the message can be extended as described in the following. In this case, the transfer process includes a receive program locate unit 60 as shown in FIG. 33. As shown in FIG. 34, the receive program locate unit obtains executable program code from send information of a receive message shown in FIG. 27 in step 75. Then, next, the receive program locate unit links the code to a program that is currently running in step 76.

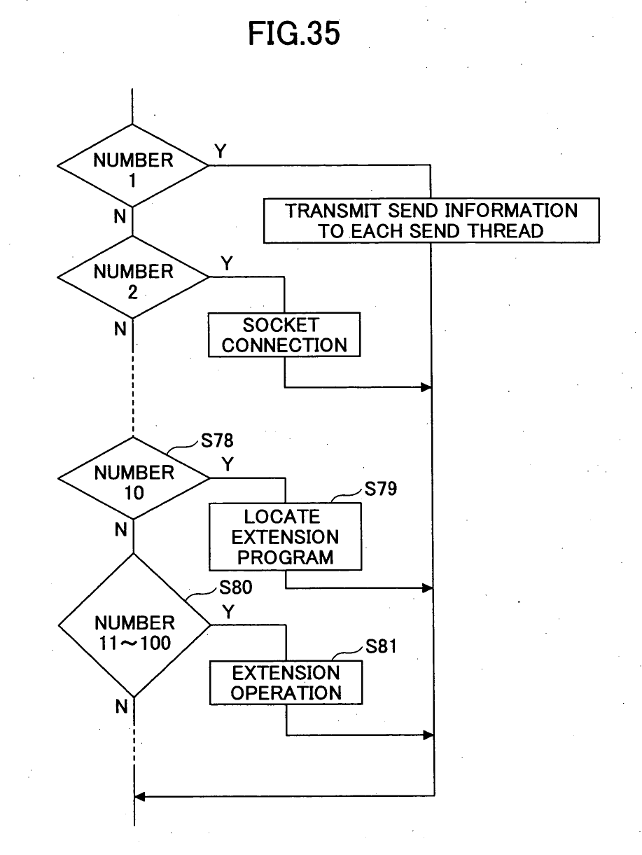

More particularly, when the program code is based on a dynamic library of binary code, the program code is loaded onto a memory and is linked, and can be loaded when necessary. When the program code is intermediate code like JAVA, the intermediate code can be loaded onto the memory by a class loader. FIG. 35 shows operation based on types of messages in the case including such extension program location.

In this example, it is assumed that the message number “10” indicates an extension program message. When the information distribution unit obtains a message of the number 10 from the send buffer (Y in step 78), the information distribution unit obtains the code from the message as shown in FIG. 34, and links the code on the memory so as to perform extension program location in step 79. In addition, the extension program has a subroutine including an interface for receiving a message as an argument, and operates for messages with numbers ranging from 11 to 100.

That is, when the information distribution unit receives a message having a message number from 11 to 100 (Y in step 80), the information distribution unit passes process to the function of the extension program in step 81. Accordingly, the send/receive process can cause the transfer process to perform a special process as necessary.

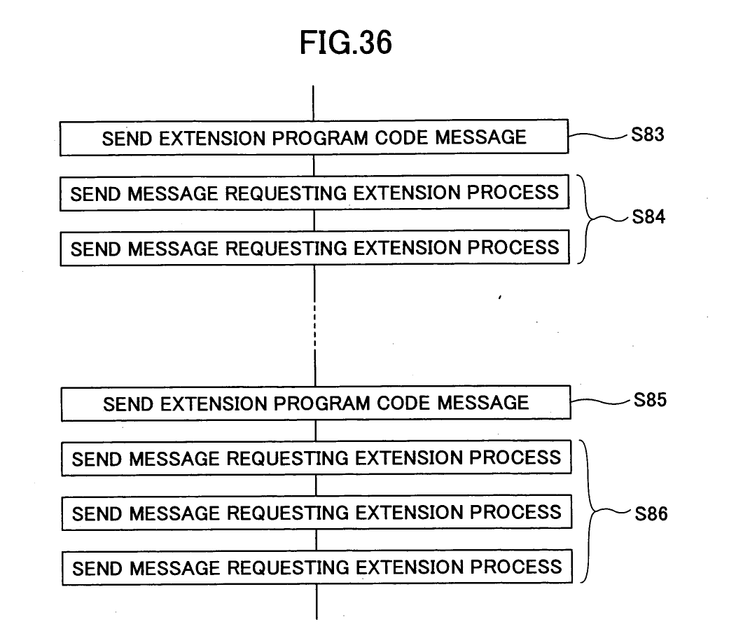

In addition, as shown in FIG. 36, after the send/receive process sends the extension program code, and sends a message for requesting the extension program to perform processes in step 84, the send/receive process can send another extension program code again in step 85 and send a message for requesting the extended program to perform processes in step 86. By adopting such form, processes can be changed as necessary only by providing an information distribution unit having a minimum function.

The extension program code may be configured to perform a process for encrypting a send message as necessary, or may be configured to change the send thread, the receive thread, the socket waiting thread and the socket connecting thread and the like of the transfer process to another schemes. Accordingly, the protocol used for network communications by the transfer process can be dynamically changed.

In addition, for example, by using the extension program code, the port number can be changed as necessary, sending order can be changed according to priority, and the communication scheme can be changed from a connection type send scheme such as TCP(Transmission Control Protocol) to non-connection type send scheme such as UDP (User Datagram Protocol) according to a type of information. In addition, the extension program may be used for purposes other than communications.

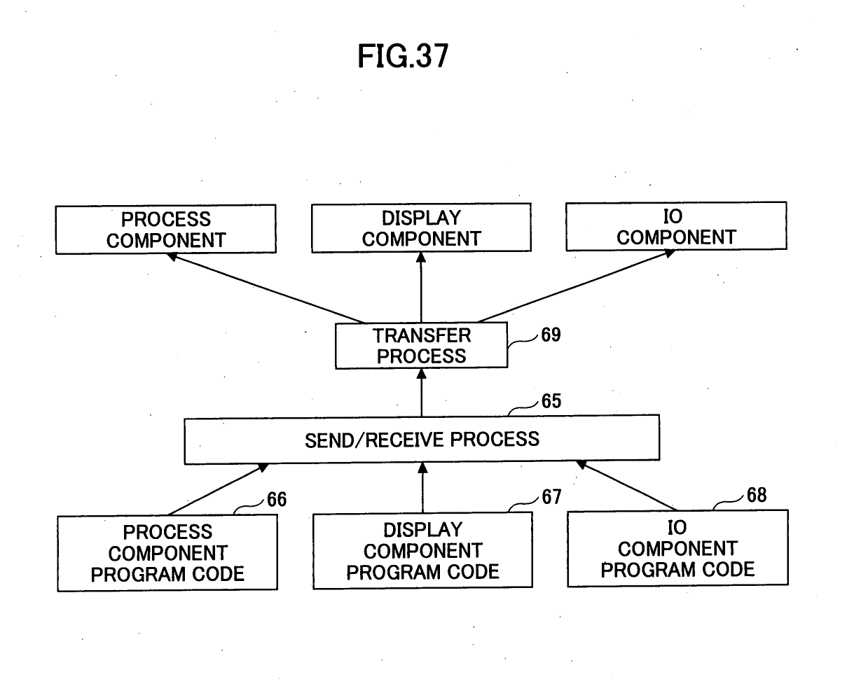

In addition, for example, as shown in FIG. 37, the send/receive process 65 can be configured to send process component program code 66, display component program code 67, IO component program code 68 or the like to the transfer process 69 so that the transfer process locates the code onto a memory to execute the code, in which the process component code is for performing various processing on a computer, the display component program code is for performing displaying operation, and IO component program code is for performing IO access.

Accordingly, common components can be shared with more send/receive processes. In addition, by sharing the components, consumption of a memory can be reduced. In addition, by devolving IO access to the transfer process, access right of the send/receive process are tightened so that only the transfer process is allowed to perform IO access. Accordingly, it can be prevented that an illegal program is mixed into the send/receive process.

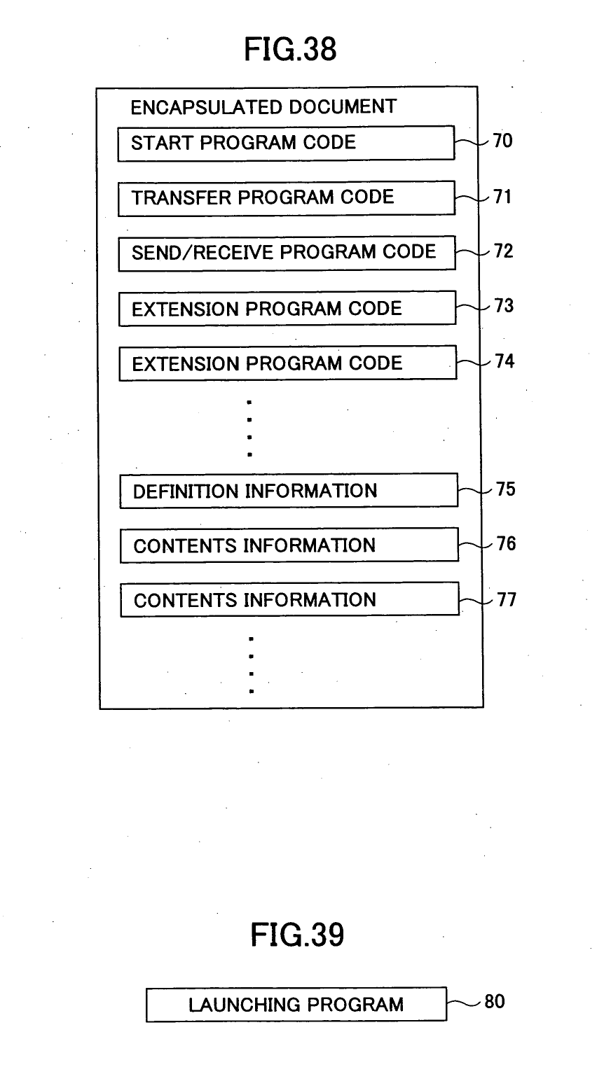

In the following, an embodiment of the present invention is described taking an encapsulated document including transfer program code and send/receive program code as an example. The encapsulated document is one like the encapsulated document shown in FIG. 2 or FIG. 5. More particularly, the encapsulated document is as shown in FIG. 38. The encapsulated document includes start program code 70 that starts before all operation starts, the transfer program code 71, the send/receive program code 72, the extension program code 73, 74, definition information 75 for defining whole operation, and contents information 76, 77 of the document.

From the viewpoint of versatility, it is desirable that each program code is described using an intermediate language such as JAVA. In addition, generally, it is desirable that the definition information is described using XML (extensible Mark-up Language) that is a meta-information description language. The contents information includes the contents of the document, and it is desirable that the document layout is described using XML, SGML (Standard Generalized Markup Language), HTML (HyperText Markup Language), SVG or the like, and that still images are stored as JPEG, TIFF or the like, and moving images are stored as MPEG or the like. In addition, it is desirable that each content is stored separately in a versatile format.

These pieces of information are integrated into a file with a proper encapsulation unit so that the encapsulated document is generated. It is desirable to use a versatile archive structure such as ZIP for the encapsulation unit. Accordingly, the encapsulated document can be processed and edited easily. As to a conventional digital document, a document editing application needs to be used for editing images in the document. On the other hand, as to the encapsulated document in this embodiment, since the versatile format is used, an application dedicated to image editing can be used so that advanced editing can be available.

For launching such encapsulated document, a launching program 80 is necessary as shown in FIG. 39. Generally, the launching program is associated with an extension of the encapsulated document and is registered in the SHELL system of the OS, so that the launching program is launched based on the association when viewing of the encapsulated document is instructed with a mouse, so that the encapsulated document is launched. It is optimal that the launching program is configured as a part of the SHELL system.

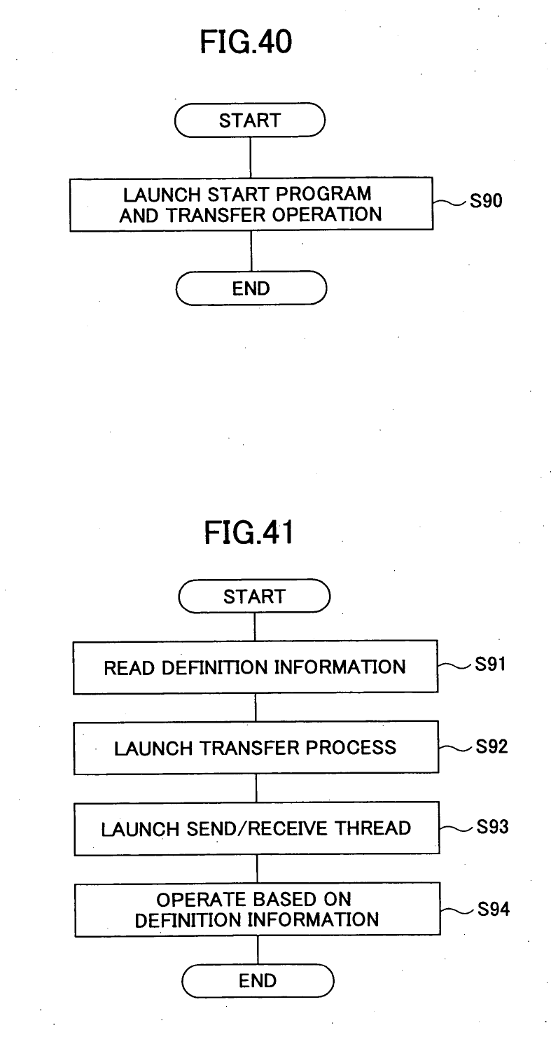

First, when a user clicks an encapsulated document that the user wants to view with a mouse and the like to instruct viewing, the SHELL system of the OS launches the launching program associated with the document file so that the launching program launches the start program of the encapsulated document as an independent process, and the launching program transfers operation and ends its operation in step 90 as shown in FIG. 40.

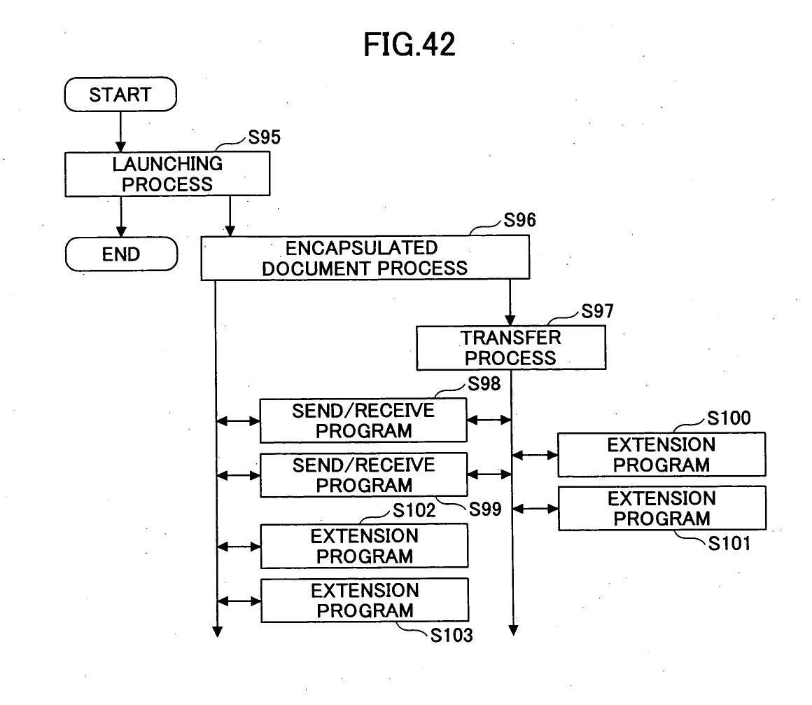

Next, as shown in FIG. 41, the start program reads the definition information of the encapsulated document in step 91 and launches the transfer program as an independent process in step 92, and launches a send/receive thread in step 93 for sending/receiving to/from the transfer program. After that, a document is displayed, for example, based on the definition information in step 94. That is, as shown in FIG. 42, the process of the launching program launches in step 95 based on instruction of the user, and starts the encapsulated document process that starts from the start program in step 96, and the launching program ends.

Accordingly, the encapsulated document process launches the transfer process in step 97. In addition, the encapsulated document process sends/receives information to/from the transfer process via the send/receive program based on the definition information (steps 98, 99), and the transfer process sends received information to a transfer process in another computer and the transfer process executes received extension program code (steps 100-103). In addition, the extension program may be executed in the transfer process or may be executed in the encapsulated document process.

In addition, by adopting the structure in which the transfer process and the code of the send/receive program that accesses the transfer process are stored in the encapsulated document, information can be sent/received flexibly, and a program can be shared with a plurality of documents. In addition, the transfer process sends the extension program to another computer as necessary so that program sharing in the whole network can be performed easily.

By the way, in the above descriptions using flowcharts, ending of each process and thread, and error processing are not described since these are not relevant to the substance of the present invention. In addition, as to the types of the message, the types can be added as necessary.

For sending information received by a receive thread of the transfer process as send information, it is not necessary to send the information to a send thread that is paired with the receive thread that receives the information, and, when transferring information, it is necessary to transfer the information optimally. These can be properly processes using send source information of the message. According to these, although various examples can be considered according to applications, since these are not relevant to the substance of the present invention, these examples are not described.

Although an example of writing is described as a using method of the document, it is needless to say that the present invention is not limited to the writing example. Since the send/receive program can send/receive any user operation such as text editing, page switching, image scaling and the like to/from the transfer process, various information entered into a computer can be shared among encapsulated documents.

That is, in the past, digital documents are handled on a local computer and distributed via a network as necessary. On the other hand, according to the embodiment of the present invention, information can be dynamically exchanged between documents via the transfer process and via the network.

In the following, more concrete examples using the configuration for performing communications between documents are described. In the examples, documents like ones shown in FIG. 4 or FIG. 8 are used.

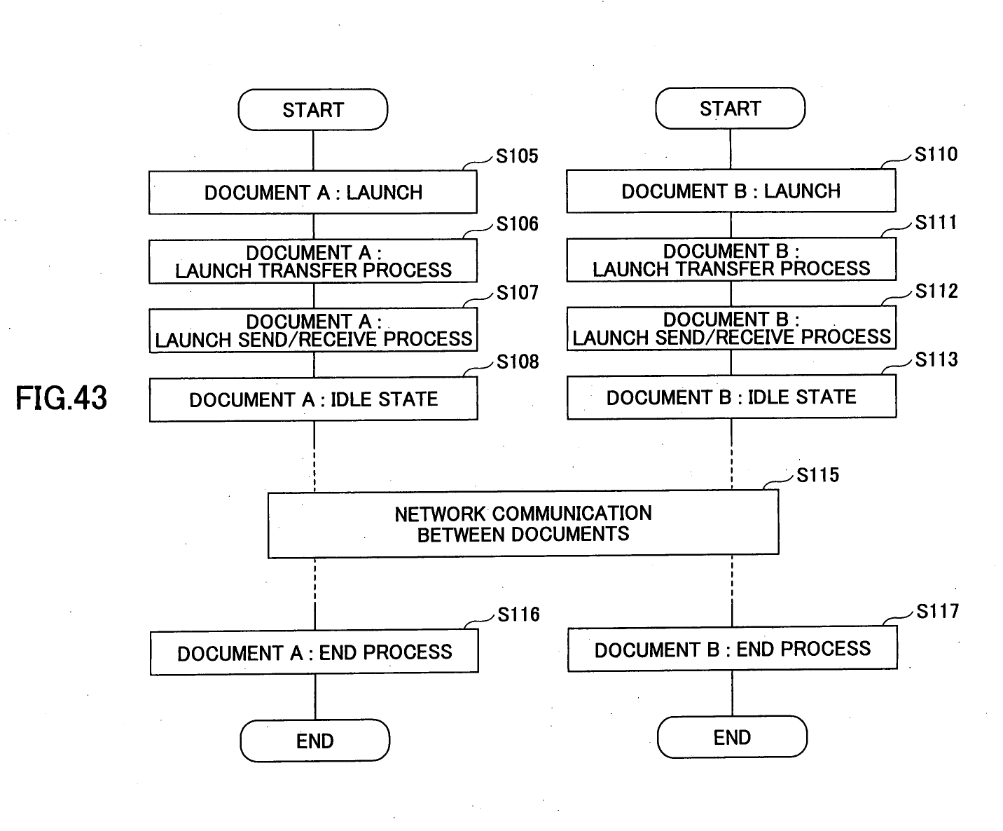

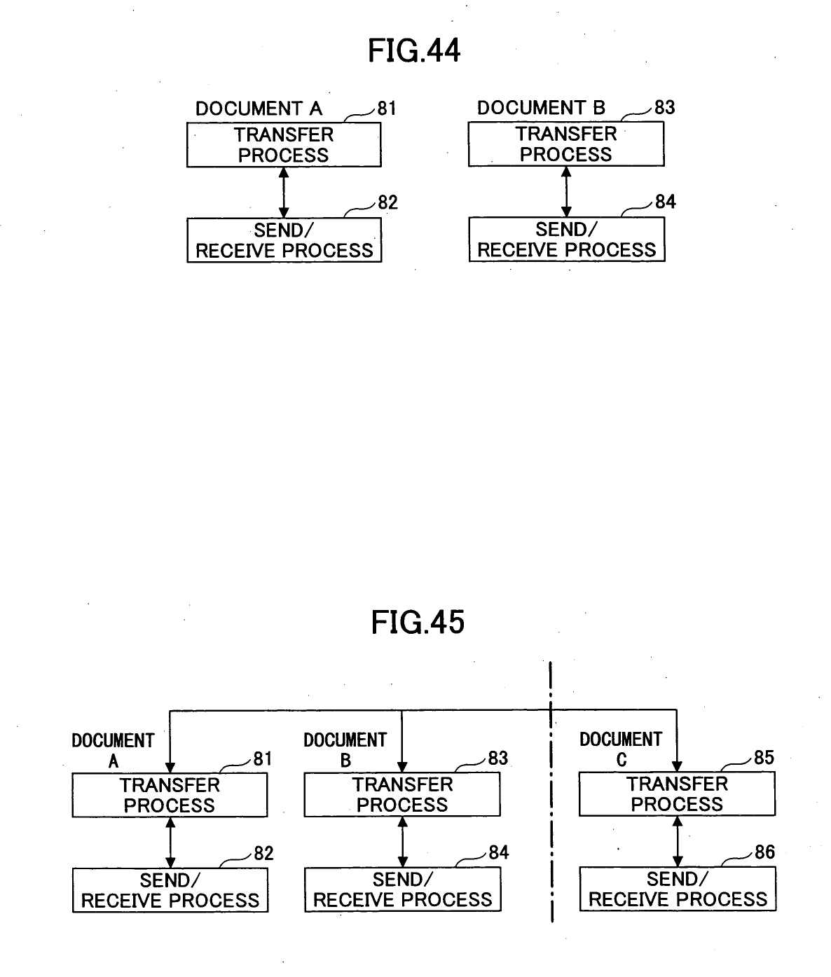

First, as shown in FIG. 43, each user launches a document by which communications are performed via a network in steps 105 and 110. More particularly, a user A launches a document A in a computer A in step 105, and a user B launches a document B in a computer B in step 110. When the document is launched, the document launches a transfer process and a send/receive process, and enters into an idle state (steps 106-108, and 111-113). At this time, the transfer process (81, 83) and the send/receive process (82, 84) operate independently in each computer as shown in FIG. 44.

After that, by sending a message like one shown in FIG. 28, the user can participate in or leave from the communications, so that network communications can be performed between the documents in step 115. At this time, as shown in FIG. 45, the document A in the computer A and the document B in the computer B are connected to each other via the transfer processes 81 and 83 as shown in FIG. 45. In addition, a transfer 85 process that is connected with a send/receive process 86 may be connected. As shown in FIG. 43, when the user performs ending operation on the document, the document is closed (steps 116 and 117).

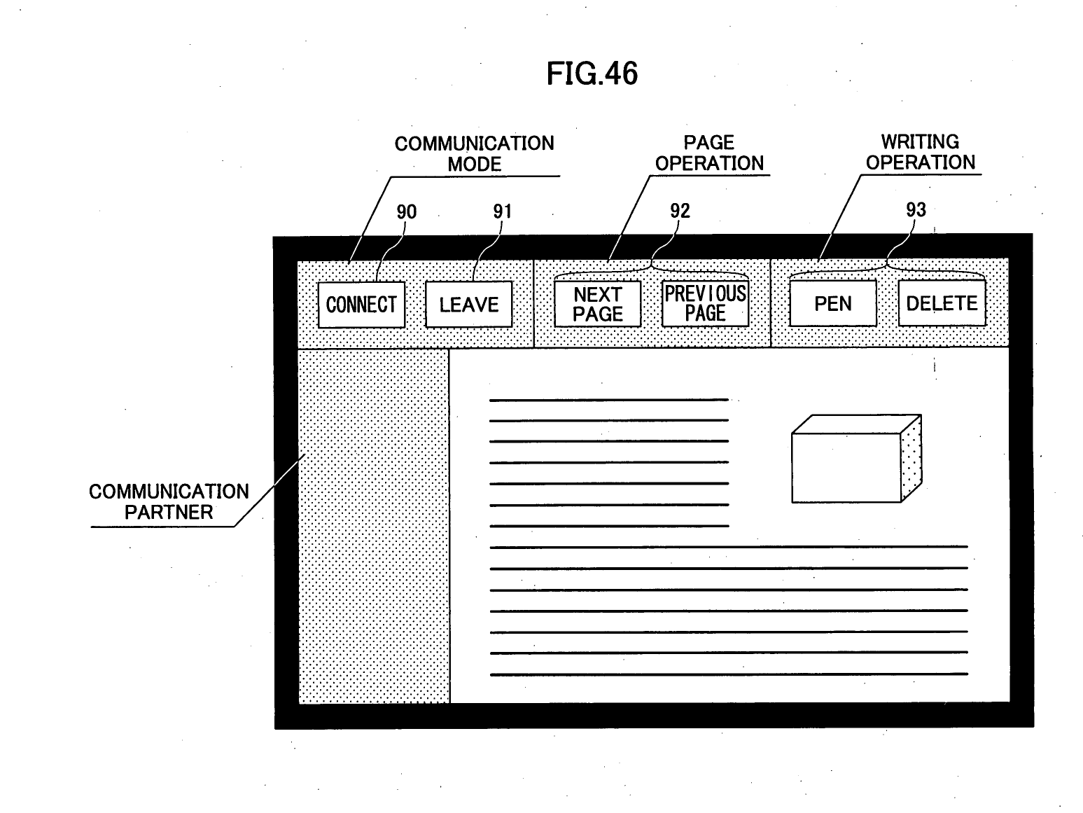

More concretely, when a document is launched, an image of the document is displayed as shown in FIG. 46. On the upper part of the image, there are a connection button 90 for changing the state of the communications, a leave button 91, a page operation buttons 92 for changing a page of the document, a writing operation buttons 93 for performing writing to realize communications with each other. On the left side, there is an area for displaying a communication partner. On the center, there is an area for displaying contents of the document.

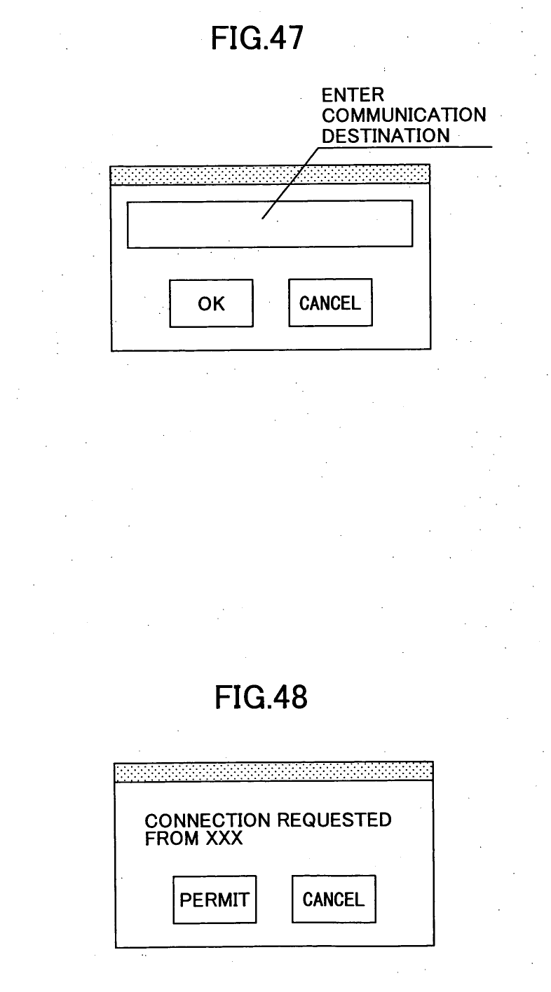

When the user pushes the connection button 90, an input frame is displayed as shown in FIG. 47 so that the user enters a communication partner. More particularly, the user may enter an IP address, a computer name, a user name and the like of the communication partner. For using the information other than the IP address, it is necessary that a service for obtaining an IP address exists on the network. As to the computer name, a general DNS service can obtain the IP address. As to the user name, a directory service can obtain the IP address. Any other methods can be used for obtaining the IP address.

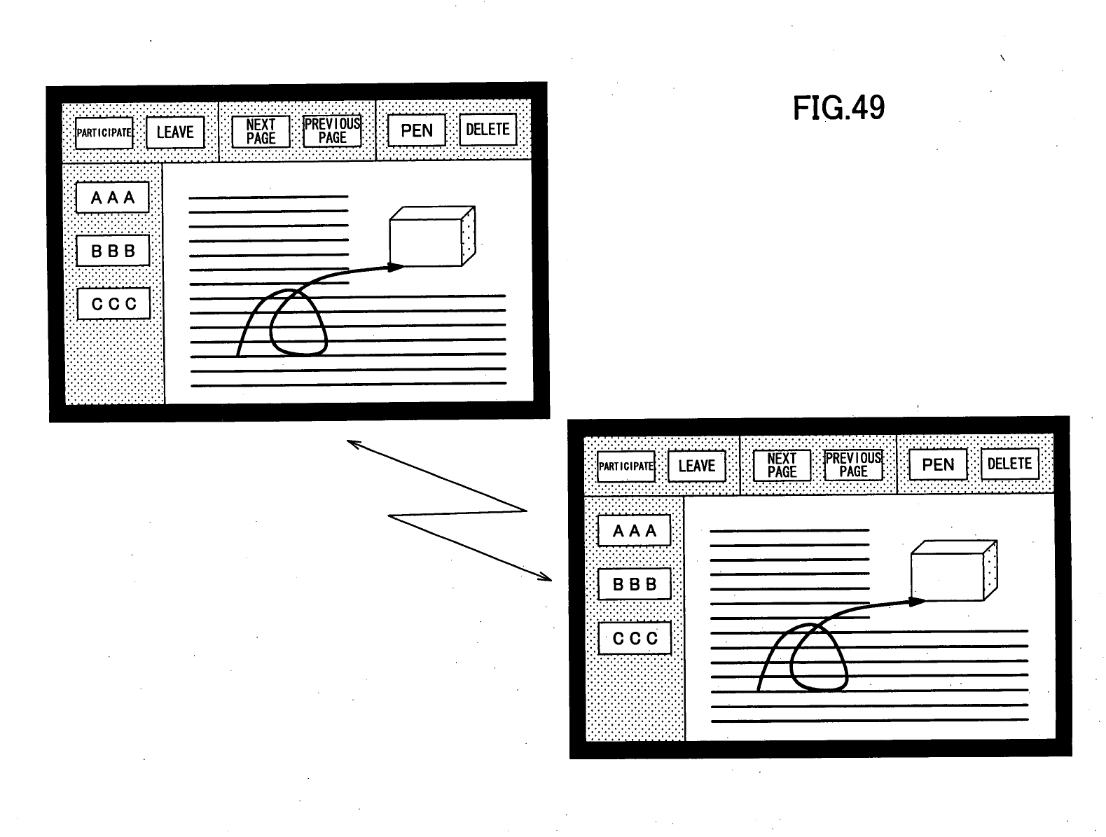

After the connection partner is determined in this way, a connection request is sent to the communication partner in an after-mentioned way, so that a frame for entering connection permission is displayed in the document B side that is the connection destination as shown in FIG. 48. Then, the user B permits connection as necessary. In this embodiment, although an example in which the user B participates in the communications by permitting the connection is shown as an simple example, connection and participation can be performed separately. Then, since the document A and the document B are connected to each other, by transmitting coordinates information of the display panel shown in FIG. 23, writing information can be displayed in each side as shown in FIG. 49.

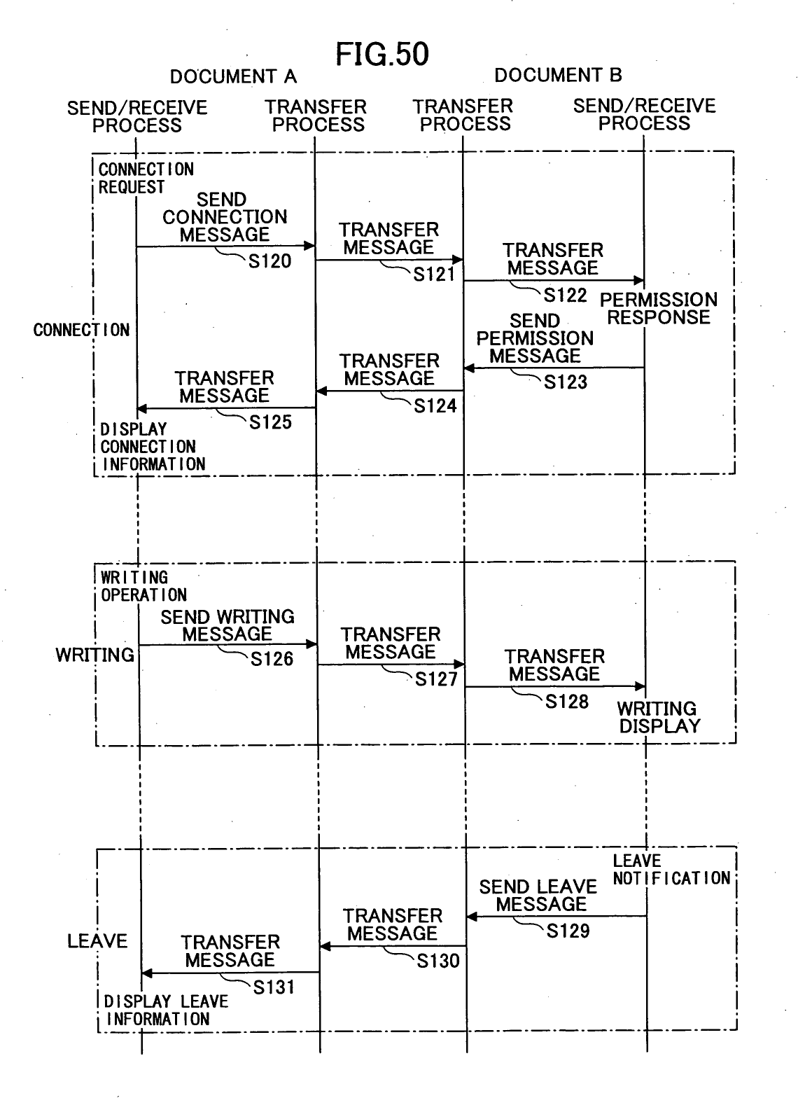

Such operation can be performed by sending and transferring messages shown in FIG. 28. FIG. 50 shows a concrete example of a sequence chart for exchanging messages. First, the connection button of the document A is pushed. After communication partner information is entered, the send/receive process generates a connection message based on the information and sends the message to the transfer process in step 120. The transfer process sends the message to a transfer process of the sending destination based on destination information of the message in step 121. The transfer process of the document B that receives the transferred message transfers the message to the send/receive process in step 122.

When the send/receive process receives the connection request message, the send/receive process displays the permission request frame as shown in FIG. 48. After permission information is entered into the frame, the transfer process sends permission message to the send source based on the source information in step 123. The transfer process of the document B sends the message in step S124, and the transfer process of the document A transfers the message to the send/receive process in step 125. The send/receive process displays information indicating that the connection is established.

That is, the send/receive process generates the message shown in FIG. 28 and the transfer process transfers the message based on destination information of the message that is received. In addition, since the message includes source information in addition to the destination information, the process that receives the message can identify a replaying destination. Accordingly, the documents A and B are connected and various information are transmitted so that communication between documents can be realized.

As to an example for the writing display operation by a mouse operation, when writing operation is performed, a message is generated. The send/receive process sends the message to the transfer process in step 126, the transfer process transfers the message to the transfer process of a communication partner in step 127. Then, the transfer process of the partner transfers the message to the send/receive process in step 128 so that the writing information can be transmitted. Thus, by displaying the information, writing information can be displayed on both of the documents. Similar communications can be also performed among more than two documents. As to leave from communications, when the leave button is pushed in the document B side, the leave message is sent from the send/receive process of the document B to the send/receive process of the document A via the transfer processes (steps 129-131).

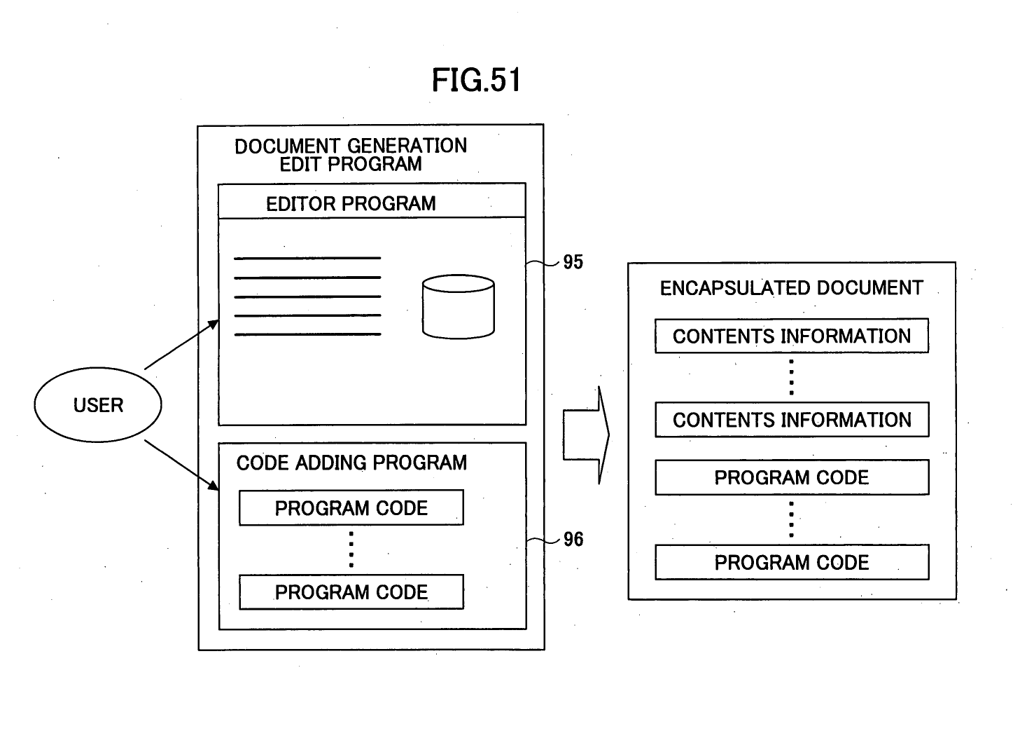

In addition, a document generation program for generating the encapsulated document is described with reference to FIG. 51. The document generation editing program includes an editor program 95 for generating contents information of the document and a code adding program 96 for adding program code that is embedded into the encapsulated document.

In FIG. 51, the editor program 95 may be a general word processing program that is used for constructing contents information using GUI. The code adding program simply adds prepared program code based on the file format of the encapsulated document. Since these techniques are not relevant to the substantial part of the present invention, more details are not described. Accordingly, the encapsulated document to which the program code is added can be generated by user operation.

Therefore, enhanced document communications can be realized by providing an optimal method for realizing network communication functions of encapsulated documents (structured documents).

According to the embodiment of the present invention, a structured document is obtained. The structured document is used in a terminal apparatus including a network function including a socket waiting unit for waiting for socket connection at a predetermined port number and a socket connecting unit for connecting to a socket at the predetermined port number, and the structured document includes a program part and a contents part, and the program part includes:

program code for causing the terminal apparatus to function as an information distribution unit having a transfer unit for sending information received from a connected socket to another connected socket; and

program code for causing the terminal apparatus to function as an information send and receive unit for connecting to the socket waiting unit for the information distribution unit so as to send and receive information.

In the structured document, the program part may include:

program code for causing the terminal apparatus to function as a receive program locating unit for executing an arbitrary program code included in information received from a connected socket;

program code for causing the terminal apparatus to function as an information distribution unit having a transfer unit for sending information received from a connected socket to another connected socket; and

program code for causing the terminal apparatus to function as an information send and receive unit for connecting to the socket waiting unit for the information distribution unit so as to send and receive information.

In the above-mentioned structured documents, the program part may further includes program code for causing the terminal apparatus to function as a detection unit for detecting whether the program code corresponding to the information distribution unit is operating.

In the above-mentioned structured documents, the program part may further includes program code for causing the terminal apparatus to function as an execution unit for determining execution of the program code corresponding to the information distribution unit based on the result of detection by the detection unit.

Also, in the above-mentioned structured documents, the program part may further includes program code for causing the terminal apparatus to function as a port number setting unit for holding predetermined port number setting information so as to set the predetermined port number.

In the above-mentioned structured documents, the program part may further includes program code for causing the terminal apparatus to function as a port number obtaining unit for obtaining the predetermined port number in the terminal apparatus.

In the above-mentioned structured documents, the information sent and received by the information send and receive unit includes distribution method determination information used for determining a distribution method of the information distribution unit, and the program part may further include program code for causing the terminal apparatus to determine a distribution method based on the distribution method determination information.

In the above-mentioned structured documents, the program part may further includes program code for causing the terminal apparatus to determine a connection destination of the socket connecting unit for the information send and receive unit based on information received from the connected socket so as to establish a new connection.

According to an embodiment of the present invention, a terminal apparatus is also provided. The terminal apparatus includes a network function including a socket waiting unit for waiting socket connection at a predetermined port number and a socket connecting unit for connecting to a socket at the predetermined port number, and further including a structured document and a launching program, and the structured document includes:

program code for causing the terminal apparatus to function as an information distribution unit having a transfer unit for sending information received from a connected socket to another connected socket; and

program code for causing the terminal apparatus to function as an information send and receive unit for connecting to the socket waiting unit for the information distribution unit so as to send and receive information, and

the launching program including a unit for causing the terminal apparatus to execute program code in the structured document.

The structured document may include:

program code for causing the terminal apparatus to function as a receive program locating unit for executing an arbitrary program code included in information received from a connected socket;

program code for causing the terminal apparatus to function as an information distribution unit having a transfer unit for sending information received from a connected socket to another connected socket; and

program code for causing the terminal apparatus to function as an information send and receive unit for connecting to the socket waiting unit for the information distribution unit so as to send and receive information, and

the launching program including a unit for causing the terminal apparatus to execute program code in the structured document.

According to an embodiment of the present invention, a program for causing a computer to generating a structured document that is used in a terminal apparatus is also provided, and the program includes code for forming a program part and a contents part in the structured document, and the program part includes:

program code for causing the terminal apparatus to function as an information distribution unit having a transfer unit for sending information received from a connected socket to another connected socket; and

program code for causing the terminal apparatus to function as an information send and receive unit for connecting to a socket waiting unit in the terminal apparatus for the information distribution unit so as to send and receive information.

As to the program, the program part may include:

program code for causing the terminal apparatus to function as a receive program locating unit for executing an arbitrary program code included in information received from a connected socket;

program code for causing the terminal apparatus to function as an information distribution unit having a transfer unit for sending information received from a connected socket to another connected socket; and

program code for causing the terminal apparatus to function as an information send and receive unit for connecting to a socket waiting unit in the terminal apparatus for the information distribution unit so as to send and receive information.

According to an embodiment of the present invention, an apparatus for generating a structured document that is used in a terminal apparatus is also provided. The apparatus includes a unit for forming a program part and a contents part in the structured document, and the program part may include:

program code for causing the terminal apparatus to function as an information distribution unit having a transfer unit for sending information received from a connected socket to another connected socket; and

program code for causing the terminal apparatus to function as an information send and receive unit for connecting to a socket waiting unit in the terminal apparatus for the information distribution unit so as to send and receive information.

As to the apparatus, the program part may include:

program code for causing the terminal apparatus to function as a receive program locating unit for executing an arbitrary program code included in information received from a connected socket;

program code for causing the terminal apparatus to function as an information distribution unit having a transfer unit for sending information received from a connected socket to another connected socket; and

program code for causing the terminal apparatus to function as an information send and receive unit for connecting to a socket waiting unit in the terminal apparatus for the information distribution unit so as to send and receive information.

The present invention is not limited to the specifically disclosed embodiments, and variations and modifications may be made without departing from the scope of the present invention.

The present application contains subject matter related to Japanese patent application No. 2005-303374, filed in the JPO on Oct. 18, 2005, the entire contents of which are incorporated herein by reference.

What is claimed is:

1. A structured document used in a terminal apparatus comprising a network function including a socket waiting unit for waiting for socket connection at a predetermined port number and a socket connecting unit for connecting to a socket at the predetermined port number, the structured document comprising a program part and a contents part, the program part comprising:
program code for causing the terminal apparatus to function as an information distribution unit having a transfer unit for sending information received from a connected socket to another connected socket; and
program code for causing the terminal apparatus to function as an information send and receive unit for connecting to the socket waiting unit for the information distribution unit so as to send and receive information.

2. The structured document as claimed in claim 1, the program part further comprising program code for causing the terminal apparatus to function as a detection unit for detecting whether the program code corresponding to the information distribution unit is operating.

3. The structured document as claimed in claim 2, the program part further comprising program code for causing the terminal apparatus to function as an execution unit for determining execution of the program code corresponding to the information distribution unit based on the result of detection by the detection unit.

4. The structured document as claimed in claim 1, the program part further comprising program code for causing the terminal apparatus to function as a port number setting unit for holding predetermined port number setting information so as to set the predetermined port number.

5. The structured document as claimed in claim 1, the program part further comprising program code for causing the terminal apparatus to function as a port number obtaining unit for obtaining the predetermined port number in the terminal apparatus.

6. The structured document as claimed in claim 1, wherein the information sent and received by the information send and receive unit includes distribution method determination information used for determining a distribution method of the information distribution unit, and the program part further comprises program code for causing the terminal apparatus to determine a distribution method based on the distribution method determination information.

7. The structured document as claimed in claim 1, the program part further comprising program code for causing the terminal apparatus to determine a connection destination of the socket connecting unit for the information send and receive unit based on information received from the connected socket so as to establish a new connection.

8. A terminal apparatus comprising a network function including a socket waiting unit for waiting socket connection at a predetermined port number and a socket connecting unit for connecting to a socket at the predetermined port number, and further comprising a structured document and a launching program, the structured document comprising:
program code for causing the terminal apparatus to function as an information distribution unit having a transfer unit for sending information received from a connected socket to another connected socket; and
program code for causing the terminal apparatus to function as an information send and receive unit for connecting to the socket waiting unit for the information distribution unit so as to send and receive information, and the launching program comprising a unit for causing the terminal apparatus to execute program code in the structured document.

9. An apparatus for generating a structured document that is used in a terminal apparatus, the apparatus comprising a unit for forming a program part and a contents part in the structured document, the program part comprising:
program code for causing the terminal apparatus to function as an information distribution unit having a transfer unit for sending information received from a connected socket to another connected socket; and
program code for causing the terminal apparatus to function as an information send and receive unit for connecting to a socket waiting unit in the terminal apparatus for the information distribution unit so as to send and receive information.
